(19) United States
(12) Patent Application Publication
(10) Pub. No.: US 2026/0148292 A1
(43) Pub. Date: May 28, 2026

(54) System and Method for Performance Optimization Using Virtual Accounts

(71) Applicant: Oz Optimizer, Inc., New York, NY (US)

(72) Inventor: Olivia Johnson, New York, NY (US)

(21) Appl. No.: 19/401,149

(22) Filed: Nov. 25, 2025

Related U.S. Application Data
(60) Provisional application No. 63/725,815, filed on Nov. 27, 2024.

(51) Int. Cl. G06Q 40/02; G06Q 20/10

(52) U.S. Cl. CPC G06Q 40/0225; G06Q 20/108; G06Q 40/0221; G06Q 40/0222

(57) ABSTRACT

A system and method for dynamic, intertemporal, priorities-based optimization of allocation of cash flow to and reallocation of the balances of virtual accounts is disclosed. The disclosed system pertains to the field of personal financial management and addresses the technical problem of fragmented, static spend and financial planning tools that lack real-time adaptability and integrated optimization of cash flow and balance sheet. The solution utilizes secure virtual accounts representing elements of a user's financial life, each assigned source-of-funds priority ranks and a receiver-of-funds priority ranks for fund allocation and reallocation of balances. A dynamic optimization engine computes an intertemporal allocation vector to balance competing priorities and achieve user goals. Real-time financial inputs trigger automatic re-optimization within secure memory, reducing latency and enhancing data integrity. A dynamic virtual representation visually depicts optimized allocations, enabling interactive user engagement and understanding of financial trade-offs. Principal uses include providing personalized feedback and recommendations.

### CROSS REFERENCE TO RELATED APPLICATION

This application claims the priority benefit of U.S. Provisional Patent Application Ser. No. 63/725,815 filed on Nov. 27, 2024. The aforementioned disclosure is hereby incorporated by reference in its entirety for all purposes including all references and appendices cited therein.

### FIELD OF THE TECHNOLOGY

This disclosure pertains to virtual accounts, and more specifically to systems and methods for dynamic, intertemporal, priorities-based optimization of the allocation of cash flow to and reallocation of the balances of the virtual accounts.

### BACKGROUND

In recent years, individuals and families have encountered increasingly intricate financial environments, characterized by fluctuating income streams, diverse liabilities, and evolving personal goals. The field of personal financial management includes tools and methodologies designed to assist users in allocating resources among necessary expenses, discretionary spending, debt obligations, and savings and investment. Traditional approaches often depend on static budgets, manual categorization of transactions, and periodic reviews, which may struggle to adapt to real-time financial activity and evolving circumstances and priorities. As the demand for more adaptive and personalized guidance continues to grow, a significant need exists for advanced technology frameworks capable of representing and optimizing an individual's complete financial situation in a dynamic manner.

Numerous digital solutions attempt to address these challenges by offering budgeting templates, automated transaction sorting, and goal-tracking features. Many mobile and web-based platforms present user interfaces for setting spending limits, monitoring account balances, and visualizing progress toward savings targets. Financial advisors and robo-advisor services likewise provide tailored recommendations based on risk profiles and market conditions. Despite these advances, most of these applications are limited in their ability to integrate cash-flow and balance-sheet considerations and adjust allocations automatically in response to real-time data. Furthermore, conventional systems typically rely on synchronizing with external custodial accounts, which can introduce latency, security vulnerabilities, and fragmented data management. As a result, users often find themselves toggling between separate tools or performing manual recalculations to maintain an up-to-date results.

A general shortcoming of conventional systems lies in their reliance on periodic updates rather than continuous adaptation. Static budgets and fixed rules can quickly become outdated when income or expenditure patterns shift unexpectedly, such as when an unanticipated expense arises in response to evolving circumstances or priorities. Siloed data structures further inhibit a cohesive view of trade-offs among competing priorities, necessities, discretionary wants, assets, liabilities, and long-term security measures, forcing users to approximate outcomes or default to rigid thresholds or pre-specified rules. This fragmentation undermines the goal of achieving a truly balanced and dynamically updated allocation of resources that aligns with personal objectives and risk preferences and evolving real-time circumstances.

More specifically, existing tools typically lack mechanisms for optimized, fine-grained reallocation of funds across multiple categories in real-time and do not leverage secure virtual accounts to mirror discrete elements of a user's financial life. Without secure, isolated virtual accounts operating within protected memory environments, users cannot readily simulate the impact of a single transaction at the sub-dollar level on a broader financial plan or observe how an unplanned bill would cascade through their spending hierarchy, both now and over future time periods and scenarios. Moreover, conventional interfaces often fail to convey the interdependencies among cash flow segments and asset or liability balances, leaving users without an intuitive means to understand how shifting one priority affects others, or provide users with the ability to optimize their finances across them. This gap highlights the need for a streamlined, interactive framework, built upon secure virtual accounts, which are capable of continuously optimizing resource allocation, including both cash flow and balance sheet, to reflect both immediate and future needs and goals while maintaining data integrity and privacy.

### SUMMARY

Embodiments of the present technology include a system and method for a dynamic, intertemporal, priorities-based optimization of a user's personal cash flow and balance sheet that combines the user's personal priorities and risk preferences with the principles of financial planning science to best balance the user's competing financial priorities and enable them to achieve their goals.

In some embodiments, virtual accounts are generated for elements of a comprehensive representation of a user's financial life, the user's financial life comprising elements of the user's personal cash flow and balance sheet. Mathematically, each of these virtual accounts is assigned priority ranks as a source and as a receiver of funds based on the user's personal goals and priorities and the principles of financial planning science. These priority rankings and the principles of financial planning science are used to determine a dynamic, intertemporal, priorities-based optimization of the allocation of cash flow to and reallocation of the balances of virtual accounts that best achieves goals of the user. Over time the allocation of a user's cash flow to and reallocation of the balances of virtual accounts are reoptimized whenever any aspect of the user's financial life changes, including their financial circumstances, priorities, and most recent real-time transactions.

In various embodiments, the role of the dynamic virtual representation includes making the results of this optimization intuitive and easy for users to interact with, understand and use. Specifically, the system and method creates and updates and reoptimizes a comprehensive virtual representation of the user's financial life. In order for the dynamic virtual representation to be easily recognized, understood, and interacted with by the user, the dynamic virtual representation includes the following. First, elements of the user's financial life, defined as elements of the user's current and projected future spending, down to the level of individual day to day expenses, as well as their assets and liabilities. Second, the dynamic virtual representation interactively responds in real-time when the user takes actions within the representation, fully updating and re-optimizing based on the principles of financial science and the user's personal goals and priorities. Third, the dynamic virtual representation provides recommendations for the user's day to day actions in areas of their financial life and allows the user to easily and intuitively understand how the recommended actions best balance their competing priorities and enable them to achieve their goals.

Some embodiments relate to a computer-implemented method for dynamic, intertemporal, priorities-based optimization of virtual accounts of a user, the method including: receiving financial inputs of the user from one or more data sources; generating, in a secure isolated memory, a plurality of virtual accounts using the financial inputs, the plurality of virtual accounts each corresponding to a discrete element of a financial life of the user and tagged with a source-of-funds priority rank and a receiver-of-funds priority rank based on goals of the user and financial planning principles; determining, via a dynamic optimization engine, for a plurality of future time intervals, an intertemporal allocation vector that sources and distributes cash flow, including by adding to and removing from balances of the plurality of virtual accounts, among the plurality of virtual accounts according to their respective priority ranks to achieve the goals of the user; and completing real-time transfers between the plurality of virtual accounts to execute sourcing and distribution of cash flow between the plurality of virtual accounts.

In some embodiments, the updated financial inputs are received in real-time and the intertemporal allocation vector is automatically re-optimized within the secure isolated memory without synchronizing with external custodial accounts thereby decreasing latency of the dynamic optimization engine.

In some embodiments, the receiving financial inputs includes automatically importing one or more of transactional data and account balance information from at least one linked external custodial account through an application programming interface.

In some embodiments, the plurality of virtual accounts include virtual accounts for income sources, spending categories classified as needs, spending categories classified as wants, savings for financial security, assets, debts and other liabilities, the plurality of virtual accounts having both the source-of-funds priority rank and the receiver-of-funds priority rank.

In some embodiments, the source-of-funds priority rank and the receiver-of-funds priority rank are refined based on factors of the user including geographic location of the user, age of the user, and other factors of the user identified based on analysis of actions of the user and performance of the user over time.

In some embodiments, the determining, via the dynamic optimization engine, for the plurality of future time intervals, the intertemporal allocation vector includes solving an intertemporal constrained optimization problem that maximizes a weighted aggregate of user goal-attainment scores subject to the source-of-funds priority rank and the receiver-of-funds priority rank for the plurality of virtual accounts.

In some embodiments, the dynamic optimization engine is configured to preserve previously satisfied higher-ranked priorities by imposing hierarchical constraints during each re-optimization cycle.

In some embodiments, encoding hierarchical constraints in each time interval mitigates oscillations during successive re-optimization cycles.

Some embodiments further include providing personalized feedback and recommendations for user financial actions to balance competing priorities and achieve financial goals based on the intertemporal allocation vector via a user interface.

In some embodiments, the providing personalized feedback includes generating a prioritized set of recommended actions that include at least one of adjusting spending on needs, adjusting discretionary spending, redirecting funds toward a savings goal, making an additional payment to reduce debt, and updating times at which goals will be reached or debts repaid.

In some embodiments, the providing personalized feedback includes generating a prioritized set of recommended transactions that include an optimal amount, sequence, and timing of payments on each of multiple sources of debt over time.

In some embodiments, the providing personalized feedback includes generating a personalized financial health report of the user that includes one or more of a summary analysis of a current financial situation of the user, a diagnosis of the user, financial health metrics of the user, recommended actions of the user, and results of a scan for risks of the user, and personalized education regarding financial science built into a plan of the user.

In some embodiments, the providing personalized feedback includes generating a response to an unplanned event by specifying a sourcing and allocation of funds across the plurality of virtual accounts that achieves goals of the user.

Some embodiments further include rendering a dynamic virtual representation of the plurality of virtual accounts and the intertemporal allocation vector via a dynamic virtual representation module, the dynamic virtual representation being a graphical depiction including graphical elements corresponding to the plurality of virtual accounts dynamically re-scaling based on changes to the intertemporal allocation vector.

In some embodiments, the dynamic virtual representation includes an interactive graphical user interface that depicts an amount of cash flow allocated to an individual virtual account of the plurality of virtual accounts or a group of virtual accounts of the plurality of virtual accounts as a visual element whose size scales with the amount of cash flow allocated to the individual virtual account or the group of virtual accounts; and resizes the visual element in real-time when the amount of allocated cash flow is updated.

In some embodiments, the dynamic virtual representation includes an interactive graphical user interface that animates cash flow paths among visual elements in accordance with results of the determining, via the dynamic optimization engine, for the plurality of future time intervals, the intertemporal allocation vector that sources and distributes cash flow.

In some embodiments, the dynamic virtual representation includes an interactive graphical user interface that depicts current or projected future balances of the plurality of virtual accounts as a visual element whose size scales with a size of that balance and resizes the visual element in real-time when that balance is updated.

In some embodiments, rendering the graphical depiction includes providing interactive zoom functionality to transition from an aggregate view encompassing multiple virtual accounts of the plurality of virtual accounts to a subset of the multiple virtual accounts.

Some embodiments further include generating a scenario simulation that projects adjustments to the intertemporal allocation vector in response to hypothetical user modifications of a priority of the user.

In some embodiments, the graphical depiction includes visual levers, the visual levers enabling the user to incrementally adjust allocations to specific financial goals or one or more virtual accounts of the plurality of virtual accounts, and to immediately view in real-time an impact on the plurality of virtual accounts.

In some embodiments, the intertemporal allocation vector is computed for user-defined periodic intervals.

In some embodiments, each source-of-funds priority rank and receiver-of-funds priority rank is determined by applying a weighted scoring function based on user-defined importance metrics and principles of financial planning science.

In some embodiments, the secure isolated memory is implemented within a hardware-based trusted execution environment that prohibits persistent storage of user-identifiable financial data outside the hardware-based trusted execution environment.

Some embodiments further include generating alerts to notify the user of risks, based on analysis of the plurality of virtual accounts, the risks including risks associated with failure of the user to execute one or more actions recommended by the determining, via the dynamic optimization engine, for the plurality of future time intervals, the intertemporal allocation vector that sources and distributes cash flow.

In some embodiments, the intertemporal allocation vector is computed for a plurality of scenarios for uncertain future events at one or more future time intervals and dynamically distributes cash flow and reallocates balances among the plurality of virtual accounts according to their respective priority ranks to optimize achievement of financial goals of the user over time across these scenarios for the uncertain future events.

In some embodiments, the intertemporal allocation vector computed for the plurality of scenarios for uncertain future events at one or more future time intervals is used to project balances in the plurality of virtual accounts for each future time interval and scenario.

In some embodiments, the intertemporal allocation vector is automatically updated in response to changes in the financial inputs, the financial inputs including new transactions, modifications to assets or liabilities, or updates to goals and priorities of the user.

In some embodiments, incremental interval-local updates reduce end-to-end re-optimization latency compared to full-model re-computation.

In some embodiments, the receiving financial inputs includes validating and normalizing API call payloads within the secure isolated memory and mapping them to discrete events that trigger interval-local updates to the intertemporal allocation vector.

Some embodiments relate to a computer-implemented method for dynamic, intertemporal, priorities-based optimization, the method including: receiving inputs related to a financial life of a user; generating virtual accounts for a plurality of elements of the financial life of the user using the inputs, the virtual accounts being assigned a source-of-funds priority rank and receiver-of-funds priority rank based on goals of the user and financial planning principles, the virtual accounts being secure and isolated using a hardware-based trusted execution environment, the hardware-based trusted execution environment managing financial data by operating within memory and not relying on external data synchronization with external custodial accounts thereby reducing latency in processing for enabling the dynamic, intertemporal, priorities-based optimization; computing and storing a time-stamped intertemporal allocation vector in a secure isolated memory, determining a dynamic, intertemporal, priorities-based optimization of allocation of cash flow to and reallocation of balances of the virtual accounts to achieve goals of the user; rendering from precomputed vector values a dynamic virtual representation of the financial life of the user to display the dynamic, intertemporal, priorities-based optimization of allocation of cash flow to and reallocation of the balances of the virtual accounts to achieve the goals of the user; performing incremental interval-local re-optimization that preserves hierarchical constraints to update the dynamic, intertemporal, priorities-based optimization of allocation of cash flow to and reallocation of the balances of the virtual accounts in response to changes in the inputs; and providing personalized feedback for financial actions of the user to balance competing priorities and achieve financial goals based on the dynamic, intertemporal, priorities-based optimization of allocation of cash flow to and reallocation of the balances of the virtual accounts.

Some embodiments relate to a computer-implemented method for providing a dynamic virtual representation of a user's financial life, the method including: generating, by one or more processors, a dynamic virtual representation including a plurality of virtual accounts, the plurality of virtual accounts corresponding to elements of a financial life of a user and assigned a source-of-funds priority rank and receiver-of-funds priority rank based on goals of the user and financial planning principles; visually grouping the plurality of virtual accounts into categories including needs, wants, and financial security, and representing each of the categories and the plurality of virtual accounts as graphical elements, the graphical elements scaling by size according to an amount of funds allocated; animating flows of funds among the graphical elements in accordance with a dynamically determined, intertemporal, priorities-based optimization of allocation of cash flow to and reallocation of balances of the plurality of virtual accounts; enabling interactive user input to adjust the source-of-funds priority rank and the receiver-of-funds priority rank; wherein the graphical elements automatically re-scale and underlying optimization is re-computed in real-time in response to the interactive user input or updated financial data using the plurality of virtual accounts; and providing, via the dynamic virtual representation, personalized recommendations and feedback for financial actions to balance competing priorities and achieve financial goals of the user.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 illustrates an environment within which systems and methods for dynamic, intertemporal, priorities-based optimization of virtual accounts can be implemented, according to embodiments of the present technology.

FIG. 2 depicts an analytics process flow of three analytic layers for dynamic, intertemporal, priorities-based optimization of virtual accounts, according to embodiments of the present technology.

FIG. 3 depicts cash flow and balance sheet overview for dynamic, intertemporal, priorities-based optimization of virtual accounts, according to embodiments of the present technology and parallels it to a robo investment advisor.

FIG. 4 shows a high level process flow for dynamic, intertemporal, priorities-based optimization of virtual accounts, according to embodiments of the present technology.

FIG. 5 depicts a Graphical User Interface (GUI) showing a user introduction and beginning of data capture, according to embodiments of the present technology.

FIG. 6 depicts a Graphical User Interface (GUI) showing a user linking financial accounts, according to embodiments of the present technology.

FIG. 7 depicts a Graphical User Interface (GUI) showing linked financial accounts of the user, according to embodiments of the present technology.

FIG. 8 depicts a Graphical User Interface (GUI) showing determining sources of income of the user, according to embodiments of the present technology.

FIG. 9 depicts a Graphical User Interface (GUI) showing an introduction to high level allocation of cash flow of the user, according to embodiments of the present technology.

FIG. 10 depicts a Graphical User Interface (GUI) showing a beginning of data capture for and diagnosis of current spending on necessities of the user, according to embodiments of the present technology.

FIG. 11 depicts a Graphical User Interface (GUI) showing example inputs for shelter of the user, according to embodiments of the present technology.

FIG. 12 depicts a Graphical User Interface (GUI) showing financial security diagnosis of the user, according to embodiments of the present technology.

FIG. 13 depicts a Graphical User Interface (GUI) showing allocation of cash flow for the user, according to embodiments of the present technology.

FIG. 14 depicts a Graphical User Interface (GUI) showing allocation of cash flow for the user between current wants and future wants, according to embodiments of the present technology.

FIG. 15 depicts a Graphical User Interface (GUI) showing a home screen of a visual presentation of holistic, integrated, and dynamic optimal personal cash flow and balance sheet management plan, according to embodiments of the present technology.

FIG. 16 depicts a Graphical User Interface (GUI) showing zooming into Needs node, according to embodiments of the present technology.

FIG. 17 depicts a Graphical User Interface (GUI) showing optimized payment amounts for debt, according to embodiments of the present technology.

FIG. 18 depicts a Graphical User Interface (GUI) showing a summary and explanation of optimized debt repayment, according to embodiments of the present technology.

FIG. 19 depicts a Graphical User Interface (GUI) showing a further summary and explanation of optimized debt repayment, according to embodiments of the present technology.

FIG. 20 depicts a Graphical User Interface (GUI) showing zooming into Financial Security node, according to embodiments of the present technology.

FIG. 21 depicts a Graphical User Interface (GUI) showing an exemplary answer to a question from the user presented visually, according to embodiments of the present technology.

FIG. 22 depicts a Graphical User Interface (GUI) showing an exemplary financial security level of the user, according to embodiments of the present technology.

FIG. 23 depicts a Graphical User Interface (GUI) showing discretionary cash flow of the user, according to embodiments of the present technology.

FIG. 24 depicts a Graphical User Interface (GUI) showing a cash flow between Day-to-day Wants and Wants Goals of the user, according to embodiments of the present technology.

FIG. 25 depicts a Graphical User Interface (GUI) showing a plurality of virtual accounts of the user, according to embodiments of the present technology.

FIG. 26 depicts a Graphical User Interface (GUI) showing transferring funds between the plurality of virtual accounts of the user, according to embodiments of the present technology.

FIG. 27 depicts a Graphical User Interface (GUI) showing a history of virtual account activity showing transfers into and out of the virtual account, according to embodiments of the present technology.

FIG. 28 depicts a Graphical User Interface (GUI) showing temporal context of virtual account activity including past and projected future cash inflows and outflows, according to embodiments of the present technology.

FIG. 29 depicts a Graphical User Interface (GUI) showing re-optimization in response to change in one or more elements of user's financial life, according to embodiments of the present technology.

FIG. 30 depicts a Graphical User Interface (GUI) showing a financial health report of the user's financial life including a summary analysis of user's current financial situation, including diagnosis and recommended actions, according to embodiments of the present technology.

FIG. 31 depicts a Graphical User Interface (GUI) showing further elements of the financial health report of the user's financial life including a summary analysis of user's current financial situation, including managing needs of the user, according to embodiments of the present technology.

FIG. 32 depicts a Graphical User Interface (GUI) showing additional elements of the financial health report of the user's financial life including a summary analysis of user's current financial situation, including financial security of the user, according to embodiments of the present technology.

FIG. 33 depicts a Graphical User Interface (GUI) showing elements of the financial health report of the user's financial life including a summary analysis of user's current financial situation, including managing financial security of the user, according to embodiments of the present technology.

FIG. 34 depicts a Graphical User Interface (GUI) showing additional elements of the financial health report of the user's financial life including a summary analysis of user's current financial situation, including managing wants of the user, according to embodiments of the present technology.

FIG. 35 depicts a Graphical User Interface (GUI) showing an optimized response to an unplanned financial event enabled by the present technology, according to embodiments of the present technology.

FIG. 36 depicts a Graphical User Interface (GUI) showing allocation of discretionary cash flow, according to embodiments of the present technology.

FIG. 37 depicts a Graphical User Interface (GUI) showing a diagnosis of percentage of income allocated to wants, according to embodiments of the present technology.

FIG. 38 describes a method for dynamic, intertemporal, priorities-based optimization of virtual accounts of a user, according to embodiments of the present technology.

FIG. 39 illustrates a computer system for implementing systems and methods according to exemplary embodiments of the present technology.

### DETAILED DESCRIPTION OF EXEMPLARY EMBODIMENTS

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood, that the disclosed embodiments are merely exemplary of the invention, which may be embodied in multiple forms. Those details disclosed herein are not to be interpreted in any form as limiting, but as the basis for the claims.

The methods and systems disclosed herein have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

The embodiments and examples described herein are provided for illustrative purposes only and are not intended to limit the scope of the subject matter disclosed. Those skilled in the art will recognize that various modifications, substitutions, and rearrangements can be made without departing from the spirit and scope of the disclosed subject matter. Additionally, certain well-understood elements and processes may be omitted or simplified to avoid obscuring the novel aspects of the disclosed subject matter. The scope of the disclosed subject matter is defined by the appended claims and their equivalents.

In the domain of personal financial management, individuals and families face increasingly complex challenges in balancing immediate needs, long-term savings, debt management, and discretionary spending. Traditional financial tools, such as static budgets, manual transaction categorization, and periodic reviews, often fail to adapt to real-time changes in income, unforeseen expenses, or evolving financial priorities. Existing solutions, including mobile and web-based platforms, provide basic functionalities such as budgeting templates, automated transaction sorting, and goal tracking. However, these systems lack the ability to integrate cash flow considerations with balance sheet dynamics, offer real-time adaptability, or provide granular recommendations tailored to individual financial circumstances. Furthermore, conventional systems often rely on external custodial accounts for synchronization, introducing latency, security vulnerabilities, and fragmented data management. This results in a disjointed financial planning experience, forcing users to toggle between multiple tools and perform manual recalculations to maintain an up-to-date financial outlook.

The present technology addresses these limitations by introducing a framework for dynamic, intertemporal, priorities-based optimization of personal cash flow and balance sheet management. The described approach leverages secure virtual accounts to create a dynamic virtual representation of a user's financial life. These virtual accounts reflect discrete elements of the user's financial life, including income sources, spending categories, assets, and liabilities. Each virtual account is assigned priority rankings as both a source and receiver of funds based on the user's personal goals, preferences, and financial planning principles. This priority-based framework enables the system to compute an intertemporal allocation vector that allocates cash flow to and reallocates the balances of virtual accounts to align with the user's financial goals while balancing competing priorities.

Unlike conventional systems, the present technology operates within a secure isolated memory environment, eliminating the need for synchronization with external custodial accounts. This architecture significantly reduces latency, enhances data security, and ensures real-time responsiveness to user questions and adaptability to changes in the user's financial life. The dynamic optimization engine continuously re-optimizes the allocation vector, preserving previously satisfied higher-ranked priorities while adapting to new circumstances. The system further employs a dynamic virtual representation to visually depict the user's financial life, enabling intuitive interaction and real-time understanding of performance trade-offs. This interactive interface allows users to explore scenarios, adjust priorities, and receive personalized recommendations for financial actions, such as discretionary spending, savings contributions, and debt repayment, all in real-time.

By integrating cash flow and balance sheet dynamics into a unified, secure, and adaptive framework, the described system offers a technological advancement over prior methodologies. This framework facilitates granular, real-time financial decision-making, improves user engagement through intuitive visualization, and aids informed financial planning by delivering actionable insights at the level of individual transactions in real-time. The system's capability to dynamically re-optimize financial allocations at sub-dollar levels and provide immediate feedback empowers users to pursue their financial objectives with enhanced efficiency, precision, and security.

Some embodiments include receiving comprehensive financial inputs of the user from one or more data sources as described herein.

In various embodiments, account creation generates the core elements of the optimization model and guides the user through capture of data required for determining user-specific parameters of the model, including elements of the user's financial life and their associated costs, the user's assets and liabilities, and the user's goals and priorities.

In addition to establishing connections to relevant electronic data sources (such as the user's financial accounts), data may be acquired by interactively guiding the user to provide key financial information about their lives (e.g., shelter, health, transportation) and their goals and priorities.

Examples are included in example embodiments of process and virtual representation below.

Some embodiments include a self-creating optimal personal cash flow and balance sheet management plan.

In some embodiments, a virtual account is generated for elements of the comprehensive data set about a user's financial life collected in the data capture step, specifically for elements of the user's sources and uses of cashflow, including income sources, spending areas, and the user's assets and liabilities.

For some embodiments, each of these virtual accounts is assigned a priority rank as a source and as a receiver-of-funds priority rank based on the principles of financial planning science and information about the user's priorities and goals gathered in the data capture step. For example, financial planning science will assign a high receiver-of-funds priority rank to virtual accounts for spending areas considered “necessities”, such as food and shelter, up to a minimum required level of cashflow for those areas. In contrast, because spending above this minimum required level in each of these areas is discretionary rather than necessary, user preference governs receiver-of-funds priority rank above the minimum required level in these areas. For example, a user whose personal preference for eating out is high relative to their preference for spending on their living space may assign a low receiver-of-funds priority rank to discretionary spending on shelter above the minimum “necessity” level and a high receiver-of-funds priority rank to discretionary spending on food above the minimum “necessity” level, while another user may express the opposite preference for discretionary spending in these two areas. As a second example, a user with a desire to retire early may place a higher receiver-of-funds priority rank on retirement savings relative to discretionary spending now, while a second user planning a longer working career may place a higher receiver-of-funds priority rank on discretionary spending over the course of that career. Priority rankings may be further refined based on factors including the user's geographic location, age, and other factors related to the user's demographic, including factors identified based on analysis of the user's actions and performance over time and/or of the actions and performance of a broader set of users collected by the system.

In various embodiments, once virtual accounts have been generated for elements of the user's financial life and priority rankings assigned to them as both a source and as a receiver-of-funds priority rank, optimization methods may be used to determine the allocation of cash flow to and reallocation of the balances of the virtual accounts that best achieves the user's goals-their optimal personal “custom balance” across their spending areas, assets and liabilities.

Examples are described below, and in example embodiments of process and virtual representation below.

Self-maintaining optimal personal cash flow and balance sheet management plan (re-optimization and regeneration).

The process steps in the section above, “Self-creating optimal personal cash flow and balance sheet management plan”, may be repeated when one or more elements of the data gathered, “Data capture”, is updated. Examples of data that may be updated include: a transaction may arrive from one of the user's linked financial accounts; an element of the user's financial life may change (a new, changed or removed income source, spending area, asset, loan, insurance policy, etc.); and the user's goals or priorities may change.

Repeating the process steps above when one or more elements of the user data gathered in section above changes ensures that the allocation of cash flow to and reallocation of the balances of the virtual accounts that best achieves the user's goals is dynamically re-optimized to the user's continuously evolving circumstances and objectives. Because the analysis is conducted using virtual accounts in memory, it may be executed with previously unavailable, near real-time response times.

Examples of optimal allocation of user cash flow and management of user assets and liabilities.

Examples of high-level elements of the optimal personal cash flow and balance sheet management plan generated include the following: split of “discretionary” funds (income remaining after needs are covered) between “Wants” (spending on and saving for non-necessities) and “Financial Security” (savings for future required spending, including retirement, and reduction in debt). Within Financial Security, funds may be allocated across a “Buffer Fund” to ensure funds are available to meet near-term liquidity needs; high interest rate debt, including prioritization of high interest rate debt repayment across multiple instances of such debt; an emergency fund; when relevant, use of emergency funds to pay-off high interest rate debt; and saving for retirement.

Examples of more granular recommendations include the following: prioritization of contributions of current cash flow to savings for future spending areas, including: periodic future expenses (e.g. contributing cash flow weekly or monthly for car insurance payments due every 6 months); unpredictable future expenses (e.g., future medical care or car repair expenses); and wants goals (e.g. saving for a vacation or house down payment). Additional granular recommendations include further prioritization of contributions of current cash flow to savings for future spending areas given: a user's level of Financial Security. In some embodiments, recent events in other areas of the user's financial life, i.e. how to adjust contributions for future spending upward or downward if these recent financial events were better or worse than planned (e.g. income and/or spending is above or below plan). For example, there might be a recommendation to “catch-up” on saving for a periodic car insurance payment at a time when more cash flow than planned is available to make up for one or more previous points in time when less cash flow then planned was available, and as a result no contribution or only a partial contribution to savings for the car insurance payment was made.

Some embodiments include continuously updated guidance to support real-time spending decisions (e.g. can I afford this now?) in the context of the user's overall (holistic) optimal personal cash flow and balance sheet management plan, including the impact of recent events on that plan.

Examples of management of assets and liabilities in conjunction with cash flow optimization include: optimally shifting funds between cashflow and debt, for example by optimizing a credit card payment amount: substituting cashflow for debt by paying more than prior month charges on the credit card, resulting in a reduction in credit card debt; substituting debt for cashflow by paying less than prior month charges on the credit card, resulting in an increase in credit card debt. Using a portion of money allocated to an emergency fund earning a low rate of interest (e.g. 3%) to pay off high interest rate (e.g. 20%) credit card debt. Identification of key risks, for example, if a user is missing insurance for an asset (e.g. a car). Recommend financial products and services that would benefit the user, given the user's financial circumstances and objectives, such as: financial accounts for an unmet need (e.g., a high yield savings account, brokerage, or retirement account for a user that has a need for an account of that kind and doesn't currently have one); loans with better terms than the user's current loans (e.g. mortgage refinancing opportunity); financial accounts with better terms than the user's current financial accounts; and insurance with better terms than the user's current insurance.

### Dynamic Virtual Representation.

According to various embodiments of the present technology, users interact with the dynamic virtual representation to both provide inputs to and to access outputs of the dynamic, intertemporal, priorities-based optimization of cash flow to and reallocation of the balances of the virtual accounts. Among other things, the virtual representation may convey the user's optimal balance across their competing financial priorities, both priorities for spending now and over time in the future, and recommended actions in the user's day to day life that align with that optimal balance. The virtual representation may also convey the allocation of the individual's constrained resources (i.e., cash flow and management of assets and liabilities) across their many competing financial priorities (both now and across time) that best achieve their goals. For example, balancing things they want to spend on now (e.g. eating out) with things they need to spend on now (e.g., shelter, health, debt repayment, and risk management via insurance), and also with future things they want to save for (e.g., travel, house down payment) and future things they need to save for (e.g., emergencies, retirement). The trade-offs among these priorities are complex, and because there are many of them, high-dimensional. This high-dimensional complexity makes a virtual representation valuable in helping users understand their best financial tradeoffs and how financial science, combined with their goals and priorities, has been used by the system to determine their optimal personal “custom balance” across spending areas, showing them the optimal go-forward allocation that will enable them to best achieve their goals and financial security, and evolving with them over time as their circumstances and objectives evolve.

In various embodiments, elements of the virtual representation may include those described below. Visual and holistic. The virtual representation may be designed to provide a simple and intuitive representation of a user's optimal allocation of cash flow to and reallocation of the balances of the virtual accounts (“custom balance”) across elements of their financial life. A holistic, integrated view of this kind may be designed to enable users to see the high-level components and trade-offs of their custom balance first, which are visible in the high-level structure of the representation. Elements of the virtual representation that enable this may include the following in various embodiments: intuitive groupings of the user's spending across areas such as needs (things a user must spend on), wants (things a user would like to spend on), and financial security (savings for future required spending, including retirement, and reduction in debt). For example, pipes, circles or similar visual representation for each grouping that scale in size based on the amount of the user's cash flow flowing into the grouping. For example, animated flows of dollars or other currencies through the pipes or between the circles or other similar visual representation. Sequential “flow” of cash flow through groupings based on their prioritization, such as: cash flow flowing to the needs grouping first, so that only the cash flow remaining after needs is available to spend on wants and financial security.

In the virtual representation, sequential flows based on priority of this kind may be conveyed visually. For example, in the example above, income may be positioned above needs, which in turn may be positioned above wants and financial security, which may be positioned on the same level. Buckets, bars, or similar visual representation for balances of virtual accounts that represent assets and liabilities within each grouping may also scale in size based on their magnitude. Personalized text may be included to provide context-relevant insights or explanations. For example, from this high level, more aggregate view the virtual representation may be designed to enable the user to “zoom in” to increasing levels of detail about specific areas of their financial life, as if they are physically approaching the area and gaining visibility to greater levels of detail about it as they do, while at the same maintaining the broader perspective provided by the structure of the overall virtual representation. The user may interact with the representation at any of these levels. Dynamic re-scaling may be used to visualize the integrated, interdependent nature of financial trade-offs of user's optimized personal cash flow and balance sheet. If the amount flowing to one area of the user's financial life changes, for example due to a user action that results in a change in the user's financial life (e.g. new car), the entire analysis may be immediately automatically reoptimized in real-time by drawing on the optimization and virtual accounts. The results of this re-optimization may be communicated visually through the rescaling of elements of the virtual representation to match their new, re-optimized values, reflecting the integrated, interdependent nature of the financial trade-offs within the user's optimal allocation of cash flow to and reallocation of the balances of the virtual accounts. For example, if the user's rent increases, the user may see visually how elements of their plan are re-optimized by observing the new scale of elements in the virtual representation, from the highest level (most aggregate elements) of the representation down to individual spending areas within it, such as how much the user will now allocate to specific day to day expenses, or how far in time the completion date of a vacation savings goal has been extended.

In various embodiments visual levers allow users to do the following: reflect their personal preferences and priorities. For example, plus and minus buttons may allow the user to incrementally adjust their prioritization of specific wants goals. Understand the impact of different financial trade-offs. For example, if the user is considering increasing the amount flowing to a specific wants goal (as noted above) they can evaluate the impact of the change before making it by exploring it as a “scenario” in the virtual representation. Under the scenario, in the virtual representation, first, a circle or pipe or other visual representation that represents the wants goal may increase in size, second, remaining elements of the user's plan will be reoptimized in response to this change, and third, the results of this re-optimization will be conveyed visually through the optimized rescaling of the remaining elements of the user's financial life, enabling the user to easily understand the multi-dimensional impact the prospective change would have across aspects of their financial life.

In some embodiments the virtual representation is interactive and dynamic. The virtual representation is interactive for the user, and automatically and dynamically reoptimizes in response to actions taken by the user within it. See examples in the “dynamic re-scaling to visualize integrated, interdependent nature of financial trade-offs of user's optimized personal cash flow and balance sheet” section above. The virtual representation also automatically updates in response to new or updated data about the user's financial life the system receives from linked data sources. For example, data about the user's most recent real-time transactions may lead the system to reoptimize based on this new information about the user's most recent actions, and their impact on the user's available cash flow and asset and liability balances.

According to some embodiments as a second example, a user's financial security in the virtual representation may be determined based on the user's level of savings and debt. If the system receives data about a new loan the user has received, the user's financial security in the virtual representation will update, as will the optimal allocation of cash flow to and reallocation of the balances of the virtual accounts throughout the virtual representation to reflect the loan's payment obligation, the proceeds of the loan, and what those proceeds were used for, for example purchase of a car and its associated future expenses. Both of these examples highlight the integrated, interdependent nature of the financial trade-offs within the user's optimal allocation of cash flow to and reallocation of the balances of the virtual accounts, as determined by the system and conveyed by the virtual representation.

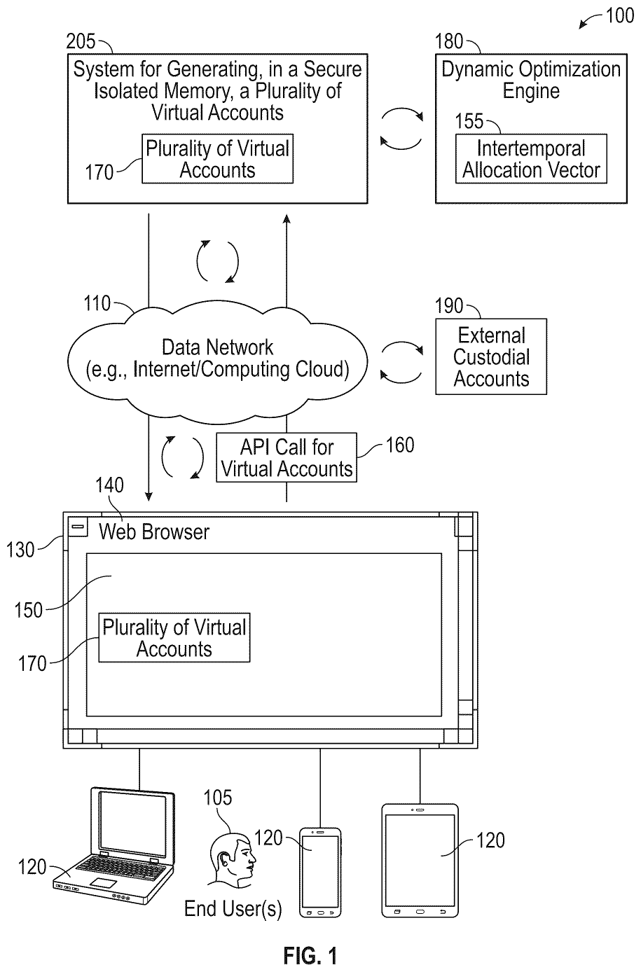

Referring now to the drawings, FIG. 1 illustrates an environment 100 within which systems and methods for dynamic, intertemporal, priorities-based optimization of virtual accounts, according to embodiments of the present technology. The environment 100 may include a data network 110 (e.g., an Internet or a computing cloud), end user(s) 105 (or user), client device(s) 120 associated with the end user(s) 105, and a system 205 for generating, in a secure isolated memory, a plurality of virtual accounts (referenced as “system 205”). Client device(s) 120 may include a personal computer (PC), a desktop computer, a laptop, a smartphone, a tablet, or so forth.

The client device 120 may have a graphical user interface (GUI) shown as a user interface 130 associated with the system 205 for generating, in a secure isolated memory, a plurality of virtual accounts 170. Furthermore, a web browser 140 may be running on the client device 120 and displayed using the graphical user interface 130. The web browser 140 may communicate with the system 205 for generating, in a secure isolated memory, a plurality of virtual accounts 170 via the data network 110.

The data network 110 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

In some embodiments, the system 205 for generating, in a secure isolated memory, a plurality of virtual accounts can determine, using a dynamic optimization engine 180, for a plurality of future time intervals, an intertemporal allocation vector 155 that sources and distributes cash flow, including by adding to and removing from balances of the plurality of virtual accounts 170, among the plurality of virtual accounts 170 according to their respective priority ranks to achieve the goals of the user 105.

In some embodiments, the system 205 for generating, in a secure isolated memory, a plurality of virtual accounts 170 can receive comprehensive financial inputs of the user 105 from one or more data sources. The system 205 may intercept an API call 160 for virtual accounts from the end user(s) 105. Upon intercepting the API call 160, the system 205 may dynamically update the plurality of virtual accounts 170 by calling the dynamic optimization engine 180 to update the intertemporal allocation vector 155.

In some embodiments, updated financial inputs are received in real-time and the intertemporal allocation vector 155 is automatically re-optimized by the dynamic optimization engine 180 within the secure isolated memory without synchronizing with external custodial accounts 190 thereby decreasing latency of the dynamic optimization engine 180.

The web browser 140 can establish a communication channel with the system 205 and generate and render the virtual representation of the plurality of virtual accounts and intertemporal allocation vector based on data received from the system 205. Specifically, the web browser 140 can render the virtual representation of the plurality of virtual accounts 170 and intertemporal allocation vector via the graphical user interface 130 to display the virtual representation of the plurality of virtual accounts 170 and intertemporal allocation vector to the end user(s) 105 on a screen 150 of the client device 120.

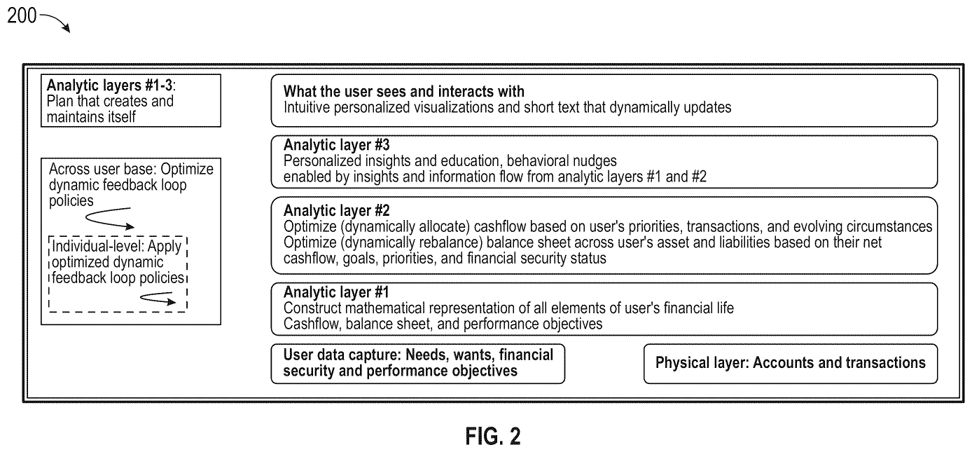

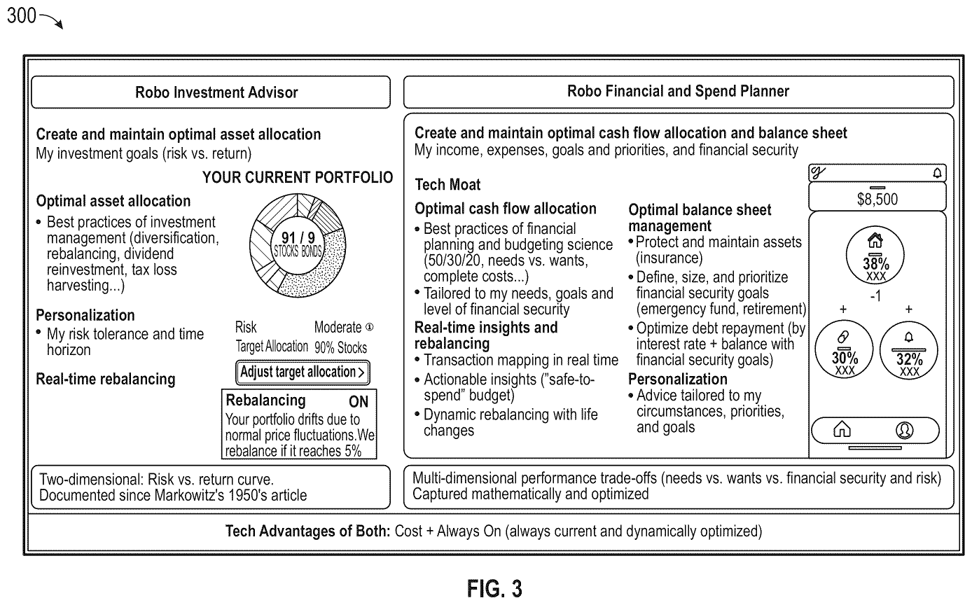

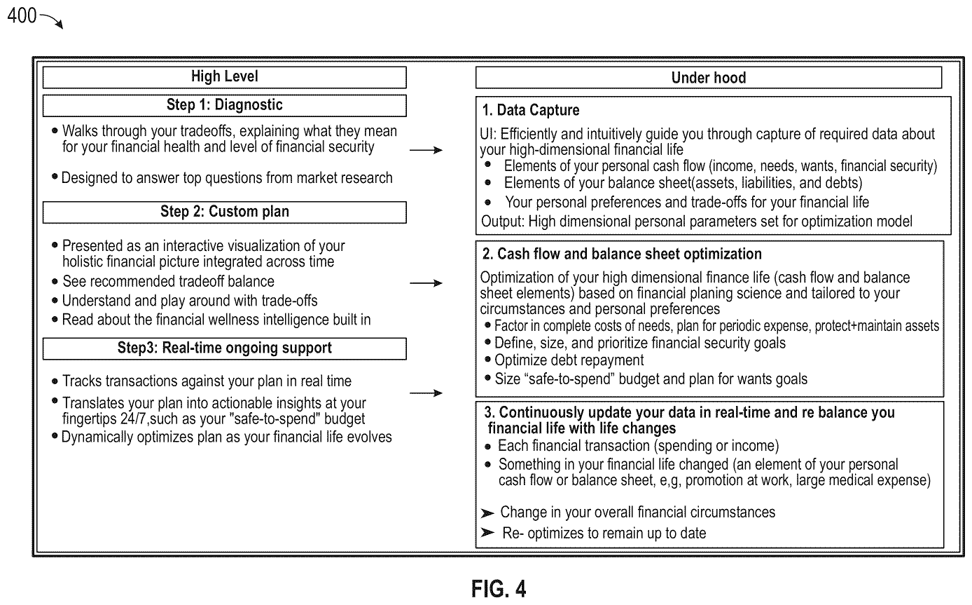

FIG. 2 depicts an analytics process flow 200 of three analytic layers for dynamic, intertemporal, priorities-based optimization of virtual accounts, according to embodiments of the present technology. FIG. 3 depicts a financial and spend planner overview 300 for dynamic, intertemporal, priorities-based optimization of virtual accounts, according to embodiments of the present technology. FIG. 4 shows a high level process flow 400 for dynamic, intertemporal, priorities-based optimization of virtual accounts, according to embodiments of the present technology.

Example embodiments of process and virtual representation according to various embodiments include the following. An exemplary embodiment includes a user introduction and beginning of data capture, financial health diagnosis, optimal personal cash flow and balance sheet management plan generation, and continuous update in real-time as the user's financial life evolves.

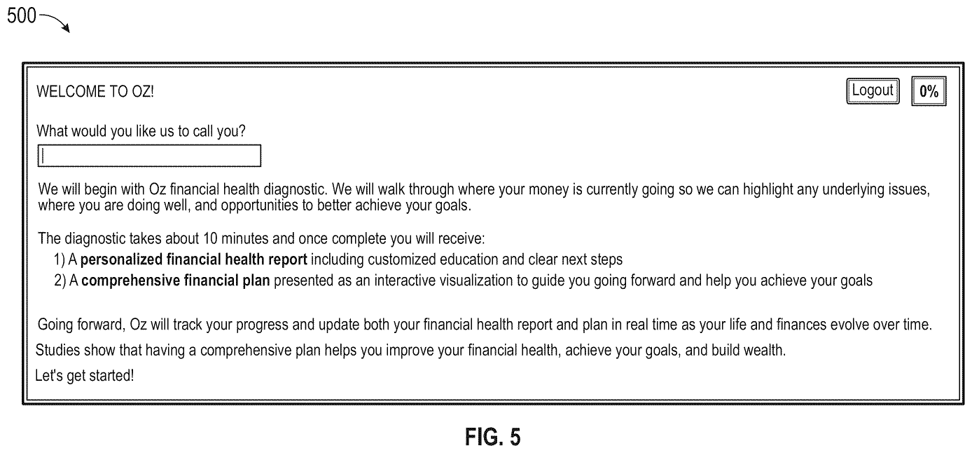

FIG. 5 depicts a Graphical User Interface (GUI) 500 showing a user introduction and beginning of data capture, according to embodiments of the present technology.

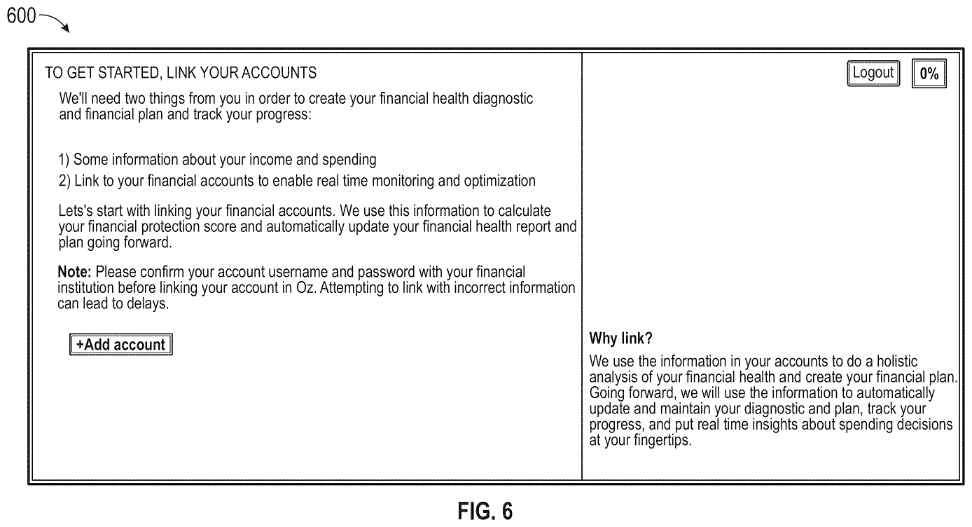

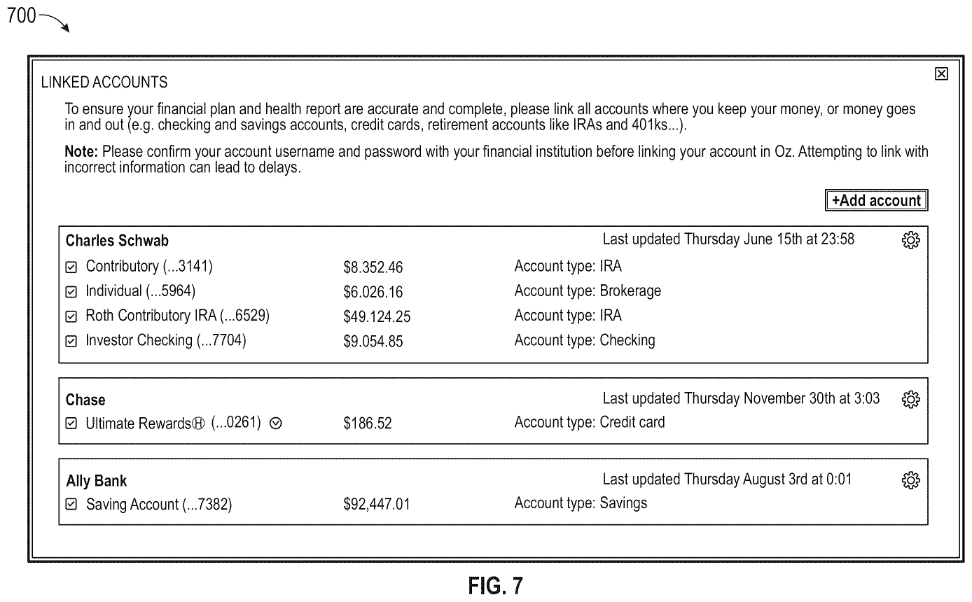

In an exemplary embodiment a user links their external custodial accounts 190 for dynamic, intertemporal, priorities-based optimization of virtual accounts. For example, FIG. 6 depicts a Graphical User Interface (GUI) 600 showing the user 105 linking financial accounts, according to embodiments of the present technology. FIG. 7 depicts a Graphical User Interface (GUI) 700 showing linked financial accounts of the user 105, according to embodiments of the present technology.

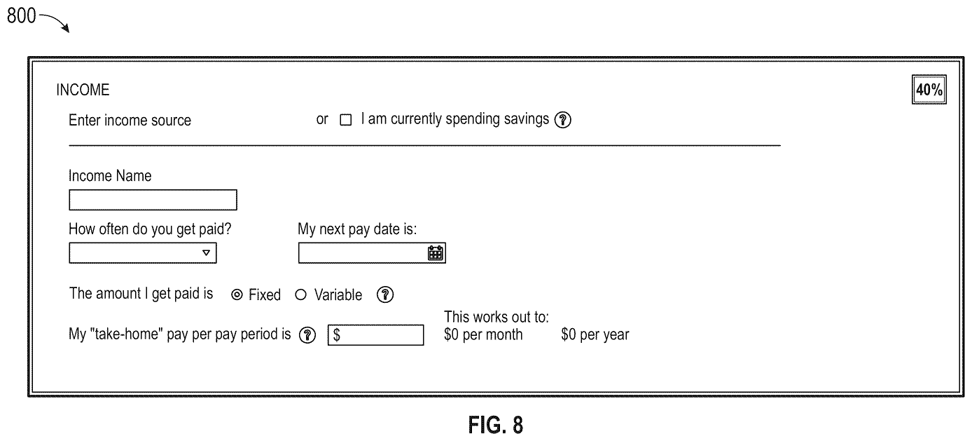

In an example embodiment of the present technology determines a user's sources of income. FIG. 8 depicts a Graphical User Interface (GUI) 800 showing determining sources of income of the user 105, according to embodiments of the present technology. For example, the present technology works for all income scenarios even if the user 105 is spending savings or funding expenses by taking on debt.

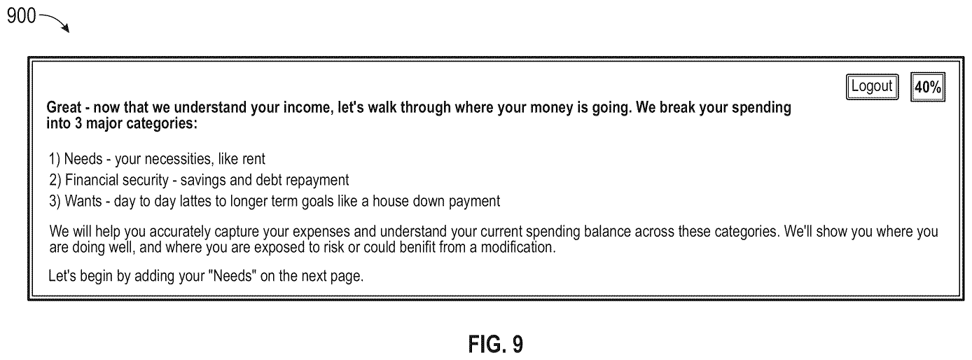

In an exemplary embodiment introduction to high level allocation of cash flow is shown in FIG. 9. For example, FIG. 9 depicts a Graphical User Interface (GUI) 900 showing an introduction to high level allocation of cash flow of the user 105, according to embodiments of the present technology.

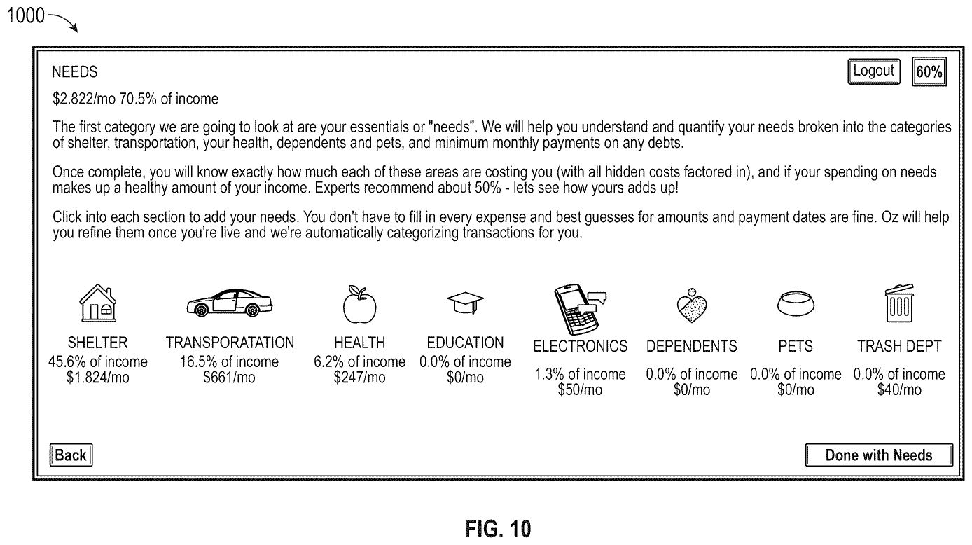

In an exemplary embodiment beginning of data capture for and diagnosis of current spending on necessities (“Needs”) is shown in FIG. 10. For example, FIG. 10 depicts a Graphical User Interface (GUI) 1000 showing a beginning of data capture for and diagnosis of current spending on necessities of the user 105, according to embodiments of the present technology.

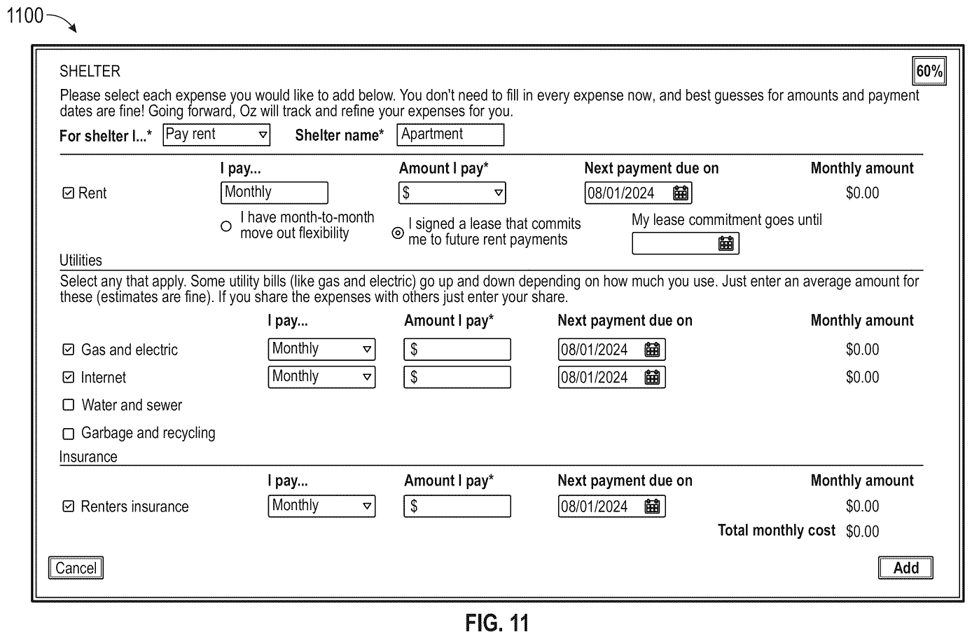

In an exemplary embodiment example inputs for shelter are shown in FIG. 11. For example, FIG. 11 depicts a Graphical User Interface (GUI) 1100 showing example inputs for shelter of the user 105, according to embodiments of the present technology. For instance, the Graphical User Interface (GUI) 1100 helps the user 105 make sure they are factoring in complete costs and planning for periodic expenses. The user 105 can select the appropriate payment interval and due dates from the dropdowns.

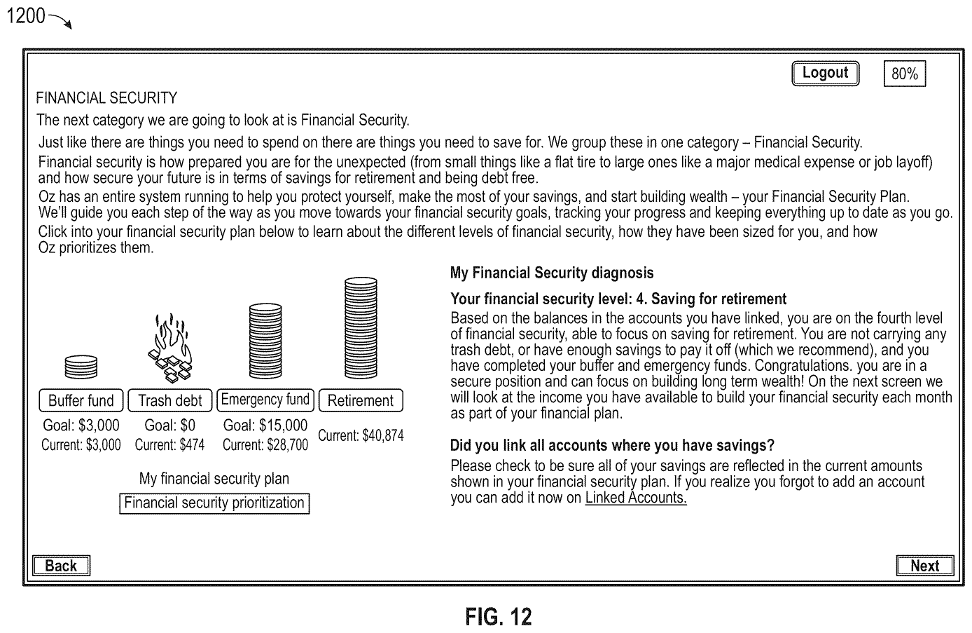

In an exemplary embodiment example financial security diagnosis is shown in FIG. 12. FIG. 12 depicts a Graphical User Interface (GUI) 1200 showing financial security diagnosis of the user 105, according to embodiments of the present technology.

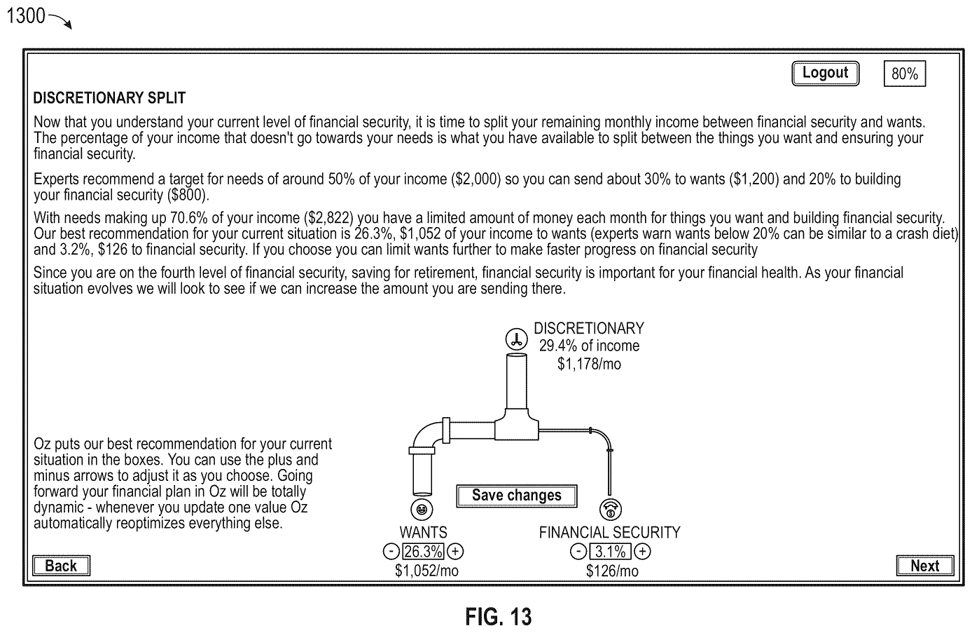

FIG. 13 depicts a Graphical User Interface (GUI) 1300 showing allocation of cash flow for the user 105, according to embodiments of the present technology. For example, allocation of cash flow between “Wants” (spending on and saving for non-necessities) and financial security.

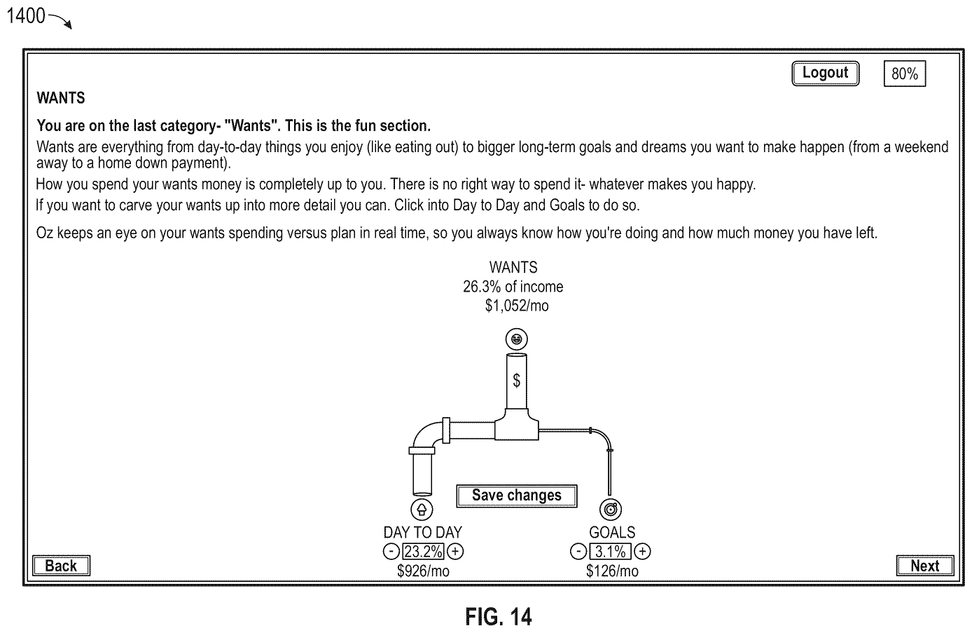

In an exemplary embodiment example allocation of cash flow for the user 105 between current wants and future wants is shown in FIG. 14. FIG. 14 depicts a Graphical User Interface (GUI) 1400 showing allocation of cash flow for the user 105 between current wants and future wants, according to embodiments of the present technology. For example, FIG. 14 shows allocation of cash flow between “day to day” wants (current wants) and wants “goals” (future wants).

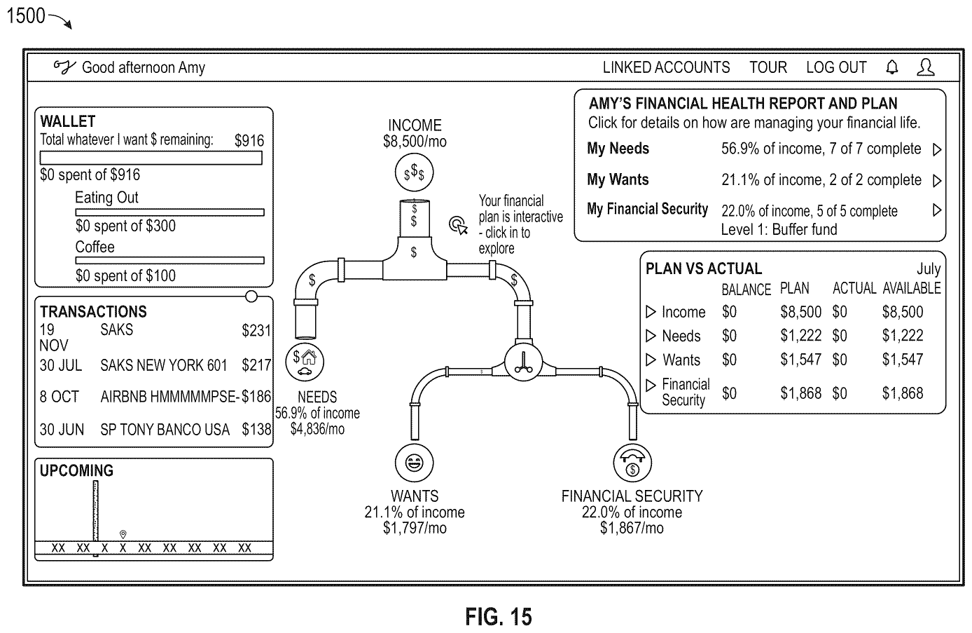

In an exemplary embodiment a home screen of the virtual representation is shown in FIG. 15. FIG. 15 depicts a Graphical User Interface (GUI) 1500 showing a home screen of a visual presentation of holistic, integrated, and dynamic optimal allocation of cash flow to and reallocation of the balances of the virtual accounts, according to embodiments of the present technology. The Graphical User Interface (GUI) 1500 of FIG. 15 depicts a highly personalized optimal allocation of cash flow to and reallocation of the balances of the virtual accounts optimized to the user's circumstances and goals including showing optimal allocation across Needs, Wants, and Financial Security, represented as percentages of income, reflecting the user's optimal personal “custom balance” across current and future spending areas and goals. For example, elements include sequential/hierarchical “money flow” through recommended allocations based on personalized financial intelligence (cash flow plus balance sheet optimization). For instance, a plan is presented as an interactive visualization such as “click to zoom in” from the “big picture” recommendation to the details. The plan is completely dynamic, and anytime the user updates something or new data is received from external sources, such as the user's financial accounts, the entire plan automatically reoptimizes (in the example pipes scale in size based on recommended allocation). For example, access to personalized text with explanations, insights, education and additional data and recommendations is shown. Some embodiments include animated flows of dollars or another currency through the pipes.

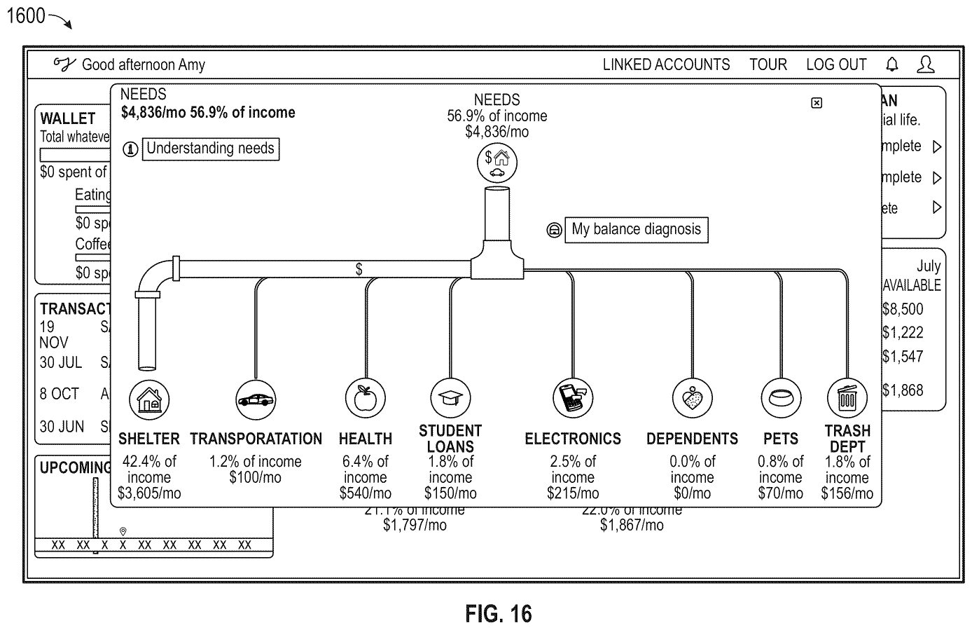

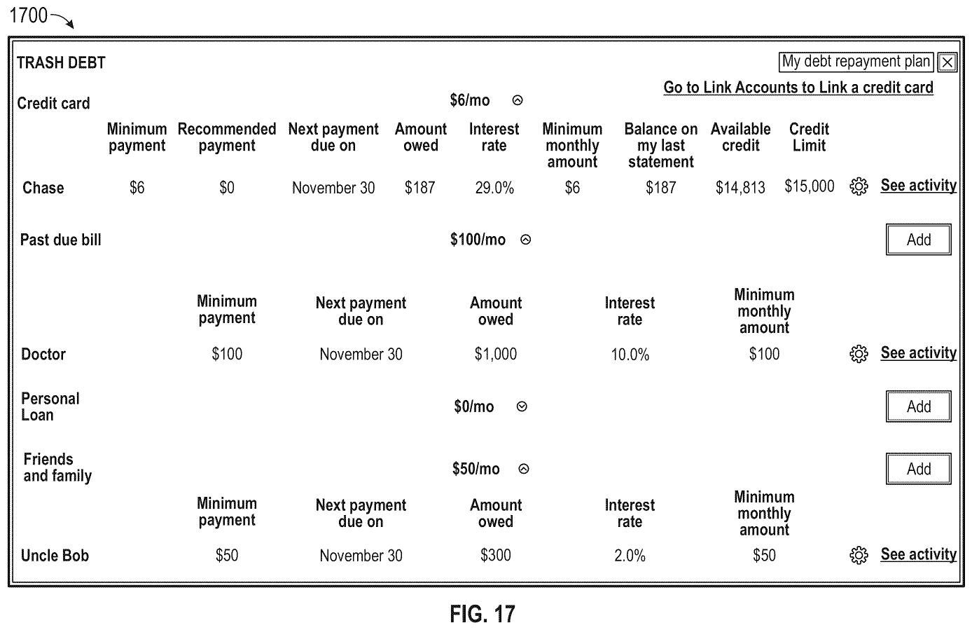

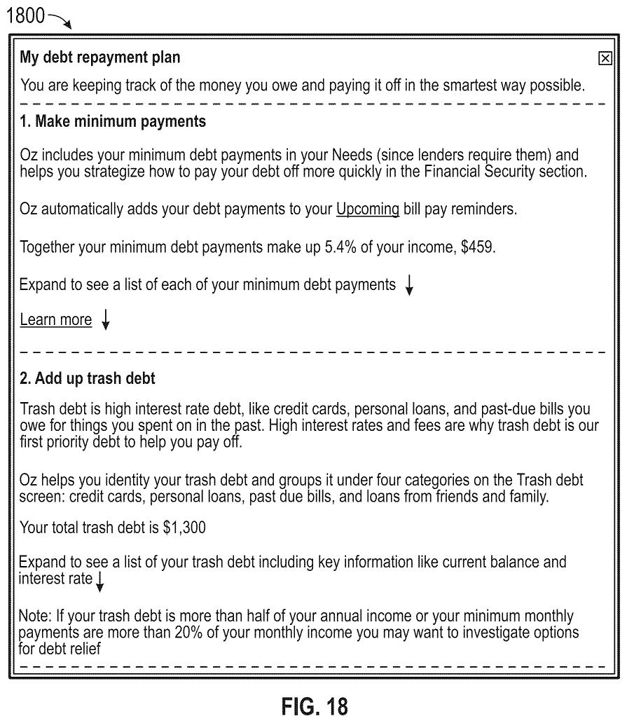

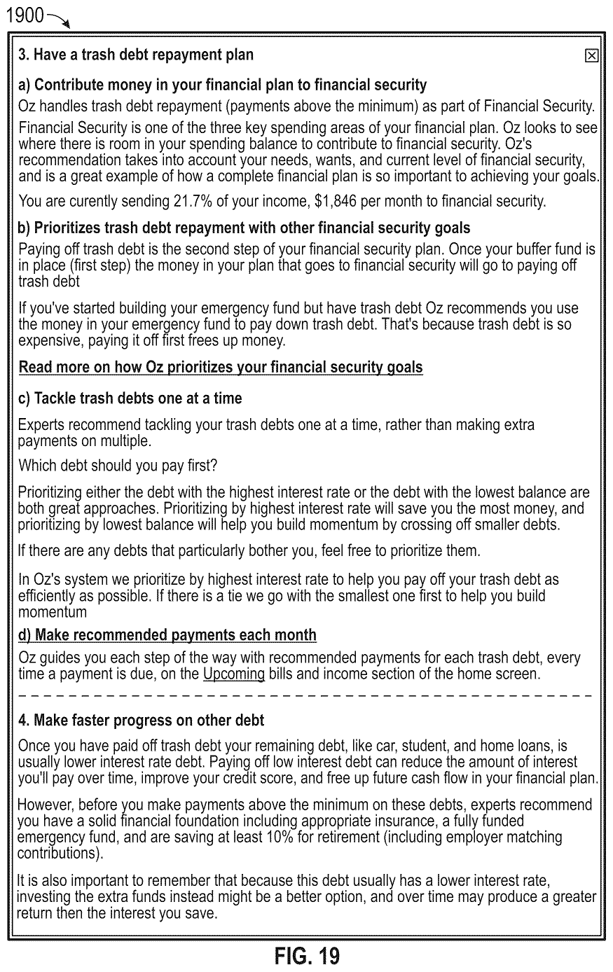

In an exemplary embodiment zooming into Needs node is shown in FIG. 16. For example, FIG. 16 depicts a Graphical User Interface (GUI) 1600 showing zooming into Needs node, according to embodiments of the present technology. For example, income flows into the Needs node first and splits into sub-flows to individual Needs categories (pipes scale based on amount flowing to each category). For example, Needs analysis may include a “balance diagnosis”, including assessing a user's Needs as a percentage of their income. Furthermore, the user 105 may zoom into Needs categories to view individual line items. For example, in the Needs category of Health, the present technology helps the user 105 plan for the expenses of doctor and dentist visits and provides recommended dates for next appointments. In an exemplary embodiment high interest rate debt repayment plan may be visualized. For example, see FIG. 17, FIG. 18, and FIG. 19. For instance, optimized payment amounts for each debt instance, reflecting prioritization of cash flow allocated to repayment of high interest rate debt across instances based on each instance's interest rate and other fees, payment due dates, amount outstanding, and user priority. Furthermore, a personalized explanation of user's optimized debt repayment plan, including required and optimal payment amounts across debt instances and types of debt. The present technology enables values to be recalculated (along with all other system outputs) automatically and immediately whenever elements of the user's financial life changes. For example, see FIG. 17, FIG. 18, and FIG. 19. FIG. 17 depicts a Graphical User Interface (GUI) 1700 showing optimized payment amounts for debt, according to embodiments of the present technology. FIG. 18 depicts a Graphical User Interface (GUI) 1800 showing a summary and explanation of optimized debt repayment, according to embodiments of the present technology. FIG. 19 depicts a Graphical User Interface (GUI) 1900 showing a further summary and explanation of optimized debt repayment, according to embodiments of the present technology.

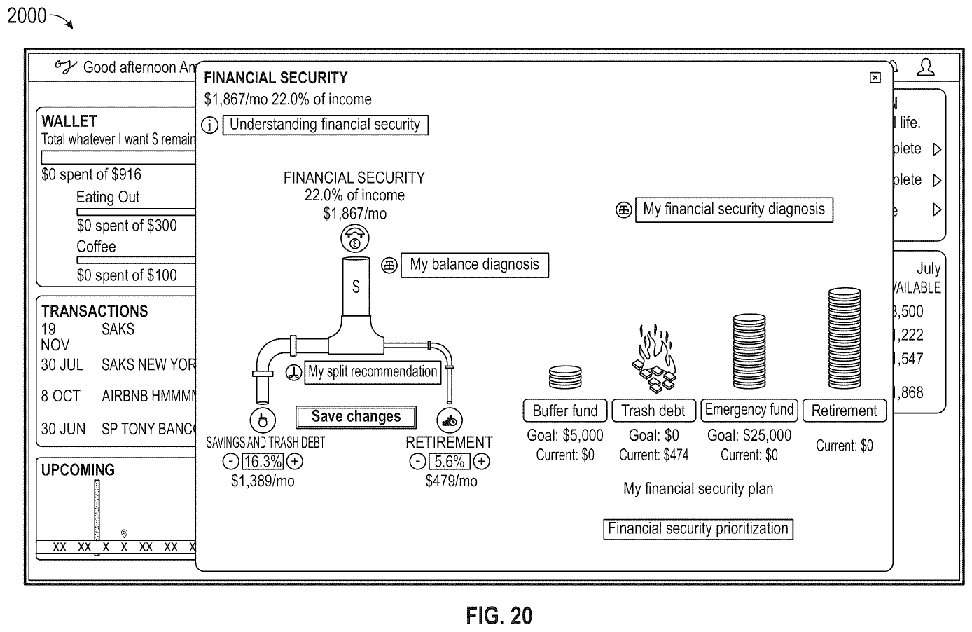

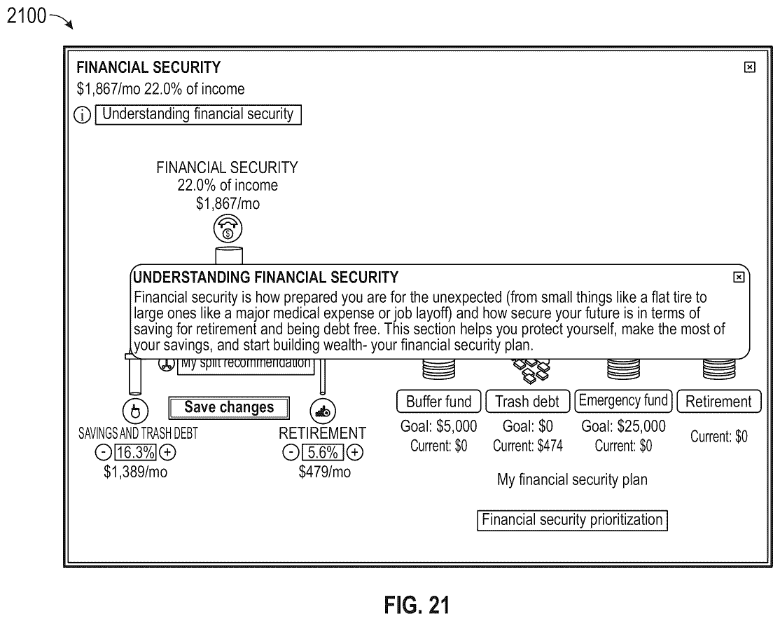

FIG. 20 depicts a Graphical User Interface (GUI) 2000 showing zooming into Financial Security node, according to embodiments of the present technology. In an exemplary embodiment elements of financial security and how they are jointly managed and optimized (e.g., savings, high interest rate debt, and retirement sub-flows) is enabled by the present technology. For example, a financial security level (score) is provided based on factors including user's level of savings and high interest rate debt. Furthermore, a recommended allocation may be provided that recommends cash flow allocation between saving for an emergency fund and paying off high interest debt vs. saving for retirement. Furthermore, additional sub-flows are enabled by the present technology that recommends allocation of non-retirement financial security funds across buffer fund, high-interest rate debt, and emergency fund, prioritization of high interest rate debt repayment across high interest rate debt instances, and when relevant, use of emergency funds to pay-off high interest rate debt. For instance, the present technology provides straightforward answers to user questions such as “How much should I save, for what, in what order?”, “How much should I pay on each of my debts, when, and why?” and “Should I use savings to pay off debt? If so, which savings and which debt?” Answers are presented visually and supported by personalized, on-demand explanations (which may include text, chatbots, videos etc.). In the example embodiments below the explanations are accessed by clicking the rectangular buttons with labels, e.g. “My Financial Security diagnosis” as shown in FIG. 21. For example, FIG. 21 depicts a Graphical User Interface (GUI) 2100 showing an exemplary answer to a question from the user 105 presented visually, according to embodiments of the present technology.

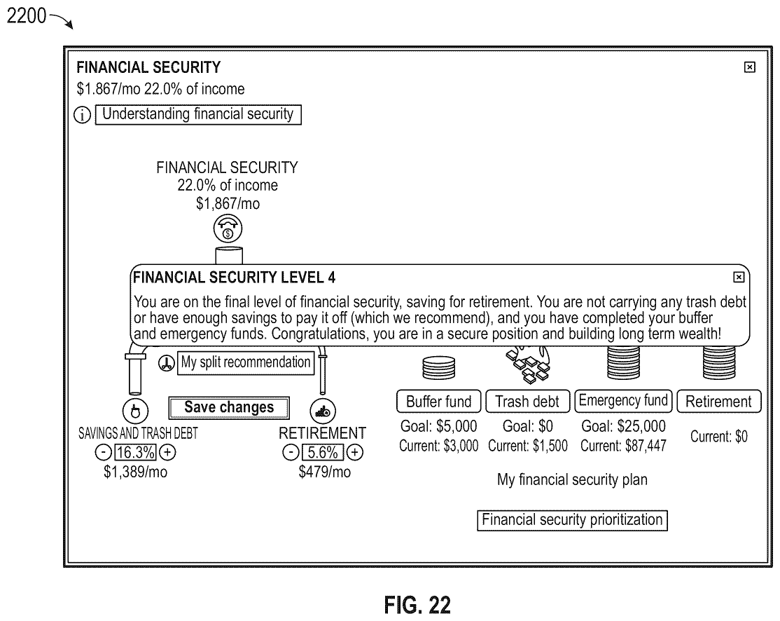

In an exemplary embodiment the present technology may provide a financial security level score based on factors including user's current level of savings and debt as shown in FIG. 22. FIG. 22 depicts a Graphical User Interface (GUI) 2200 showing an exemplary financial security level of the user 105, according to embodiments of the present technology. For instance, the present technology updates the financial security level and cash flow allocation in response to financial events and other events in the user's financial life. For example, if the user 105 has an unexpected emergency and their emergency fund is depleted, their financial security level and recommended allocation to financial security automatically updates.

In an exemplary embodiment the present technology may size and prioritize financial security goals for the user 105, and track their progress to completion. For example, the financial security level score may include the following: Level 1: Building a Buffer Fund, Level 2: Paying off high interest rate debt; Level 3: Building an emergency fund; and Level 4: Retirement.

In an exemplary embodiment the present technology may provide financial security “balance diagnosis” including cash flow to allocate to Financial Security as a percent of income, based on factors including Needs and Financial Security Level and may also include personalized explanations of implications for the user's financial health.

In an exemplary embodiment the present technology may provide a recommended allocation of financial security cash flow to financial security sub-areas, based on factors including user's level of financial security.

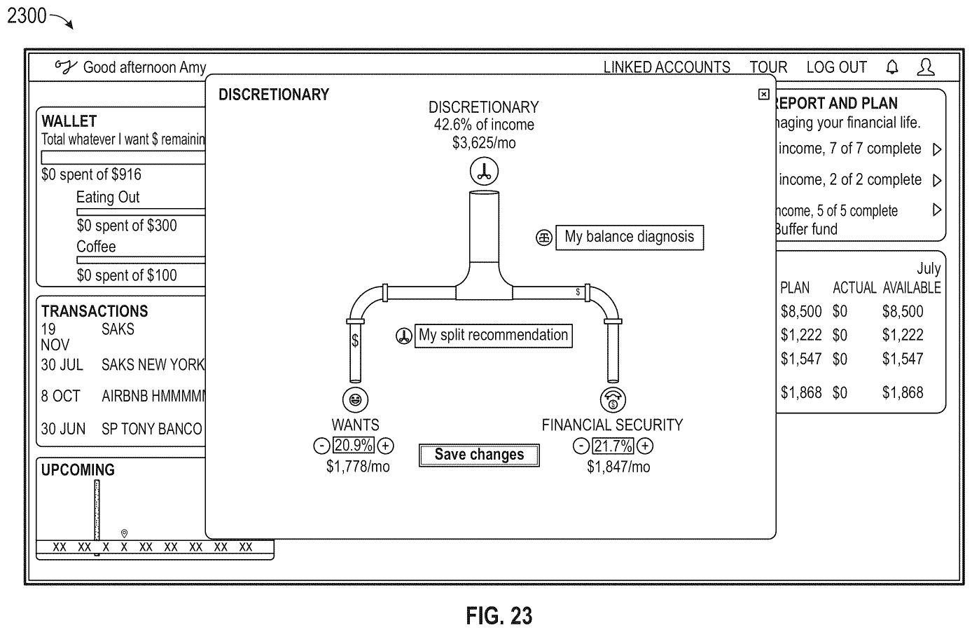

In an exemplary embodiment the present technology may provide allocation of discretionary cash flow to Wants and financial security sub-flows as shown in FIG. 23. FIG. 23 depicts a Graphical User Interface (GUI) 2300 showing discretionary cash flow of the user 105, according to embodiments of the present technology. For example, income cash flow flows to Needs first, so only the remaining “discretionary” cash flow is available to allocate between Wants and Financial Security. For instance Needs may be positioned above Wants and Financial Security, which are on the same level below, to show this sequential, hierarchical flow. The present technology enables a recommended allocation of discretionary cash flow between Wants and Financial Security that is based on financial planning intelligence and the user's circumstances and priorities. The user is able to modify the recommendation to reflect their personal preferences using the plus and minus levers, which causes the entire plan to dynamically reoptimize.

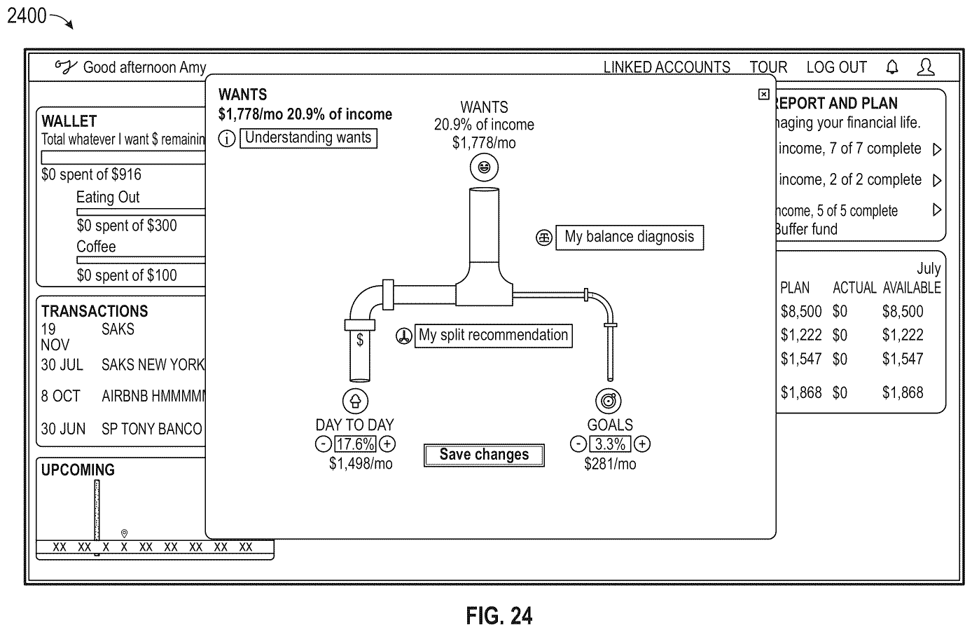

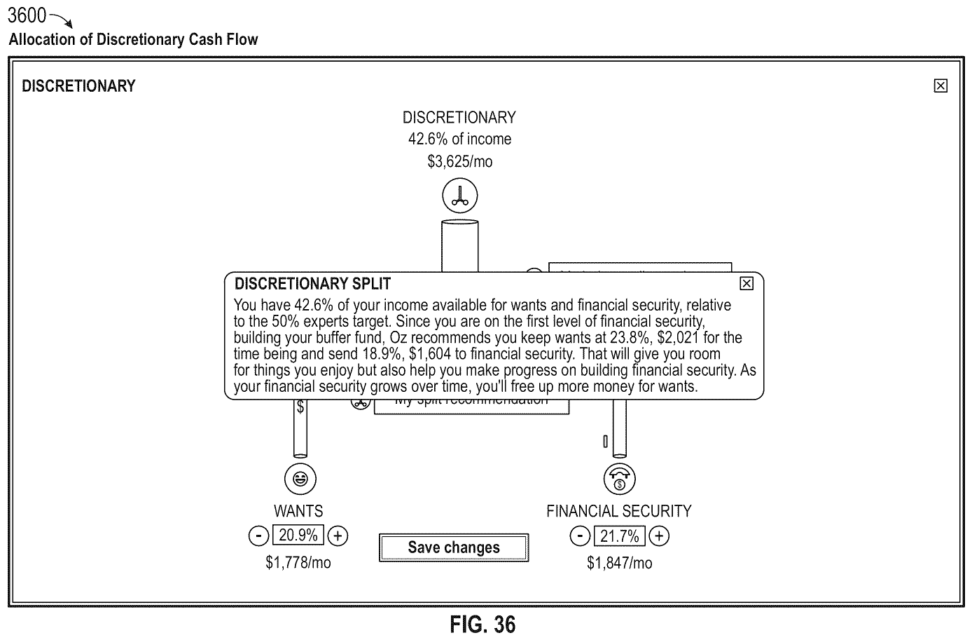

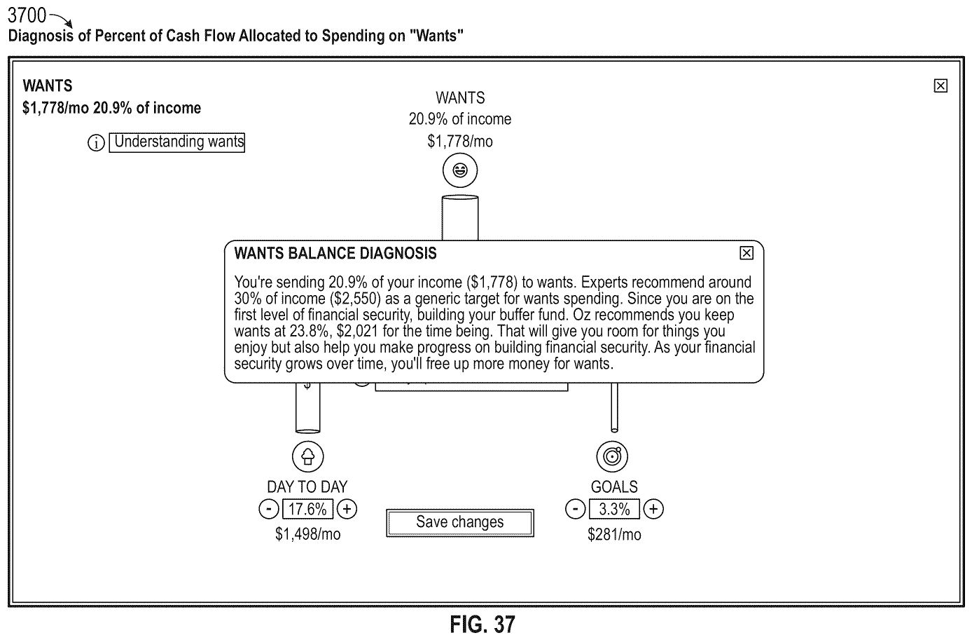

In an exemplary embodiment of the present technology may provide a diagnosis of user's discretionary cash flow as percent of income, based on factors including Needs percent and level of Financial Security, as shown in FIG. 36. FIG. 36 depicts a Graphical User Interface (GUI) 3600 showing allocation of discretionary cash flow, according to embodiments of the present technology. In an exemplary embodiment of the present technology provides a recommended allocation of discretionary cash flow between Wants and Financial Security based on factors including user's Needs, level of Financial Security, and preference for Wants versus Financial Security that reflects joint optimization of allocation of cash flow to and reallocation of the balances of the virtual accounts, via Financial Security considerations, as shown in FIG. 37. FIG. 37 depicts a Graphical User Interface (GUI) 3700 showing a diagnosis of percentage of income allocated to wants, according to embodiments of the present technology. Other relevant factors may include age, location, or demographic-specific factors of the user, including those identified based on analysis of user actions and performance collected by the system. For example, the present technology may provide recommended allocation of Wants cash flow between Day-to-day Wants and Wants Goals sub-flows as shown in FIG. 24. FIG. 24 depicts a Graphical User Interface (GUI) 2400 showing a cash flow between Day-to-day Wants and Wants Goals of the user, according to embodiments of the present technology. For example, a user can adjust recommendation with plus and minus toggles to capture personal preferences and priorities (e.g. if they want to allocate more to Wants Goals for an upcoming wedding).

In some embodiments the present technology provides a Wants “balance diagnosis” (cash flow allocated to Wants as percent of income, based on factors including Needs and level of Financial Security). In some embodiments, the present technology provides a recommended allocation of Wants cash flow between Day to Day Wants and Wants Goals, based on factors including the user's Needs and level of Financial Security.

In an exemplary embodiment of the present technology enables a user to track how much of their day to day Wants cash flow they are spending on specific spend areas (e.g. coffee, eating out) and to “reserve” cash flow for a special activity or recurring monthly subscription or membership (e.g. gym membership).

In an exemplary embodiment the present technology enables users to add Wants goals and their target timelines, and calculate the optimal allocation of cash flow to achieve those goals in the context of the user's overall allocation of cash flow to and reallocation of the balances of the virtual accounts.

In exemplary embodiments of the present technology helps a user to live with their plan. For example, all elements of user's optimal allocation of cash flow to and reallocation of the balances of the virtual accounts are reoptimized in response to changes in elements of user's cashflow and balance sheet. The present technology ensures guidance for day-to-day decisions is always up to date. For example, a “Smart wallet” supports day-to-day spending decisions in context (e.g. Can I afford this now?), showing the amount of cash flow the user currently has available for day-to-day Wants, overall and for each of their specific day-to-day Wants spending areas. The “Smart wallet” is continuously updated based on recent events in user's financial life.

In an exemplary embodiment the present technology enables real-time tracking against a plan plus an automatic “square-up”. For instance, a user may view transactions and changes in balances across virtual accounts. Transactions are auto-categorized using knowledge of the user's financial life, as represented with virtual accounts in the virtual representation. For example, a virtual representation shows a user how they are tracking against their plan over time, from high-level categories to any specific part of their plan. For instance, if user overspent in one area, re-running the optimization automatically “squares-up” by recommending the optimal way to source and allocate available funds by priority rank to get back on track. In various embodiments, a virtual representation may be tailored to phone display.

In an exemplary embodiment of a user living with their plan, the present technology auto-categorizes transactions, and provides an opportunity for user to confirm or correct the data if required.

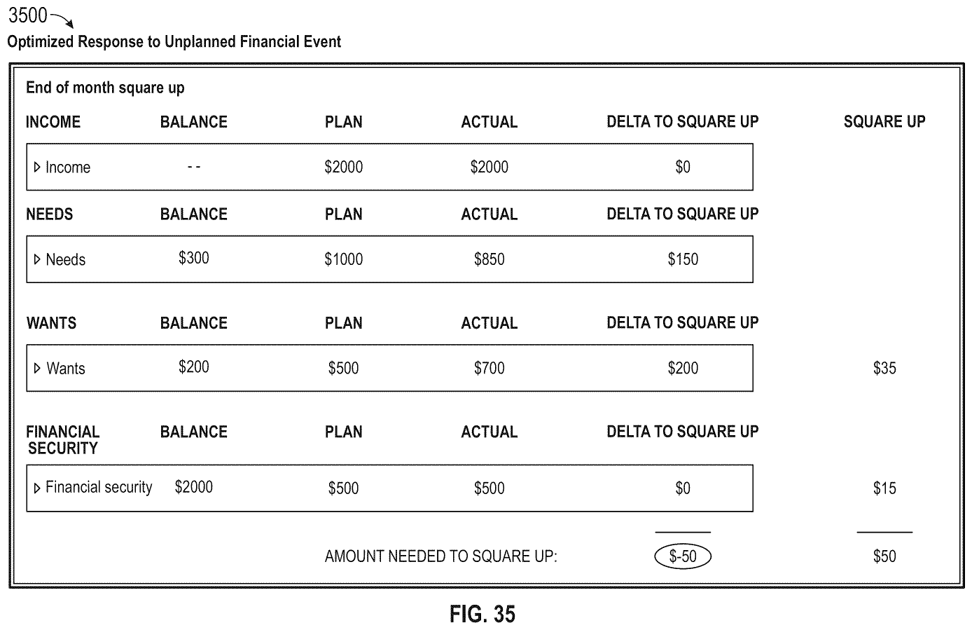

In another exemplary embodiment of a user living with their plan, the present technology provides an automated recommended “square up” of differences between user's planned and actual spending by area. For example, see FIG. 35. FIG. 35 depicts a Graphical User Interface (GUI) 3500 showing an optimized response to an unplanned financial event enabled by the present technology, according to embodiments of the present technology. For instance, if a user overspends in one area, the system enables the user to “square-up” by recommending the optimal way for the user to source and allocate required funds by priority rank. For example, overspending on Wants may be covered with a combination of cash flow, for example excess cash flow from underspending on Needs, and balances in virtual accounts, such as available balances in “asset” virtual accounts for Wants and Financial Security, or by increasing balances in “liability” virtual accounts, such as virtual accounts for debt.

In another exemplary embodiment of a user living with their plan, the present technology provides a presentation of high level summary of planned vs. actual cash flow and joint optimization of transfers to and from virtual account balances to cover difference between planned vs. actual cash flow.

In another exemplary embodiment of a user living with their plan, the present technology provides an expansion of planned and actual spending in Needs and Wants.

In another exemplary embodiment of a user living with their plan, the present technology provides an alternative summary expansion of planned versus actual cash flow by cash flow area that also includes virtual account balances for each area. For instance, a combination of planned versus actual cash flow and virtual account balances shows total funds available in each area.

In another exemplary embodiment of a user living with their plan, the present technology provides another alternative expansion of planned versus actual cash flow and virtual account balances for Wants expense cash flow and dedicated savings.

In another exemplary embodiment of a user living with their plan, the present technology provides another alternative expansion of planned versus actual cash flow for a specific spending area showing history by time period.

In another exemplary embodiment of a user living with their plan, the present technology provides an alternative expansion of planned versus actual history by period for a specific spending area where a balance is carried (shows both cash flow and balance history of virtual account).

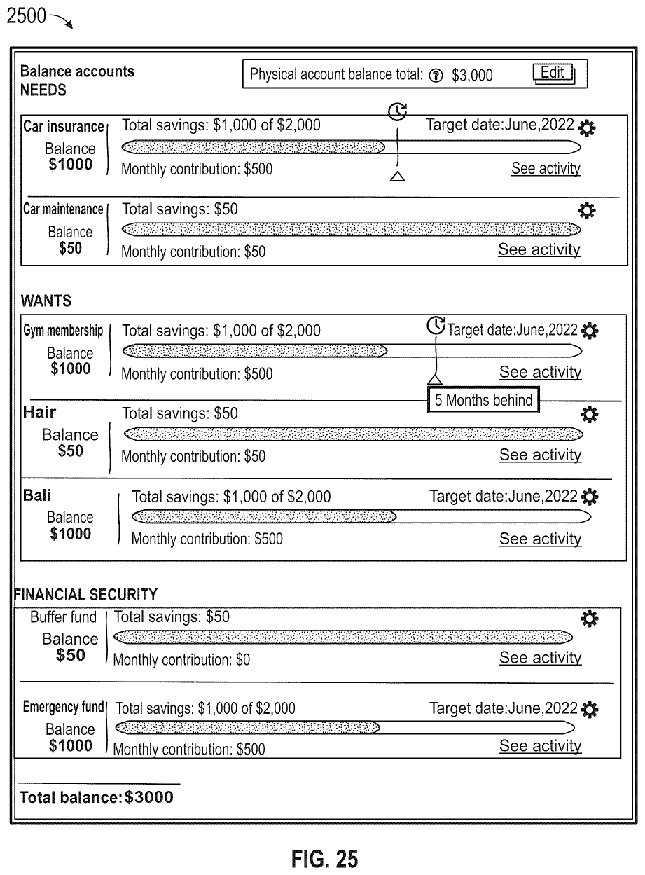

In another exemplary embodiment of a user living with their plan, the present technology provides an expansion to show current status of each of a plurality of virtual accounts 170, including the following as shown in FIG. 25. For example, FIG. 25 depicts a Graphical User Interface (GUI) 2500 showing a plurality of virtual accounts 170 of the user, according to embodiments of the present technology. First, the current balance of each of plurality of virtual accounts 170. Second, where relevant, each of the virtual account's goal amount and if relevant, a target date. Third, the difference between the virtual account's current and target balances. For example a virtual account with a current balance below target balance, the system will optimize “catch-up” contributions subject to available cash flow and virtual account balance funds and the relative priority of the sources of those funds versus the priority of the account with the deficit.

In another exemplary embodiment of a user living with their plan, the present technology provides a sum of the balances in the virtual accounts of the system, for example as shown in the exemplary embodiment above, the present technology matches the sum of the asset and liability balances in the user's linked external custodial accounts 190 at financial institutions shown on the Graphical User Interface (GUI) 700 of FIG. 7 showing linked financial accounts of the user 105.

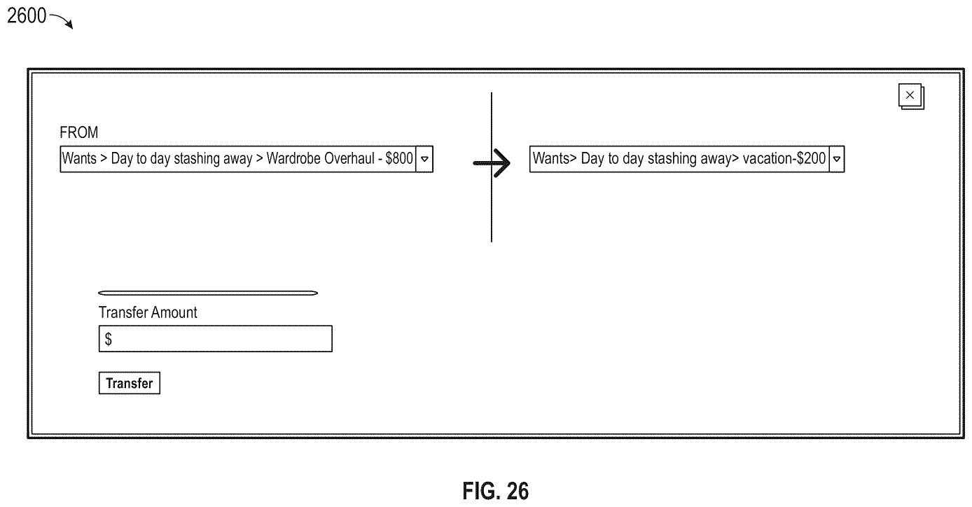

In another exemplary embodiment of a user living with their plan, the present technology provides an opportunity for user to manage the plurality of virtual accounts 170 of the user by transferring funds between the plurality of virtual accounts 170 as shown in FIG. 26. For example, FIG. 26 depicts a Graphical User Interface (GUI) 2600 showing transferring funds between the plurality of virtual accounts 170 of the user, according to embodiments of the present technology.

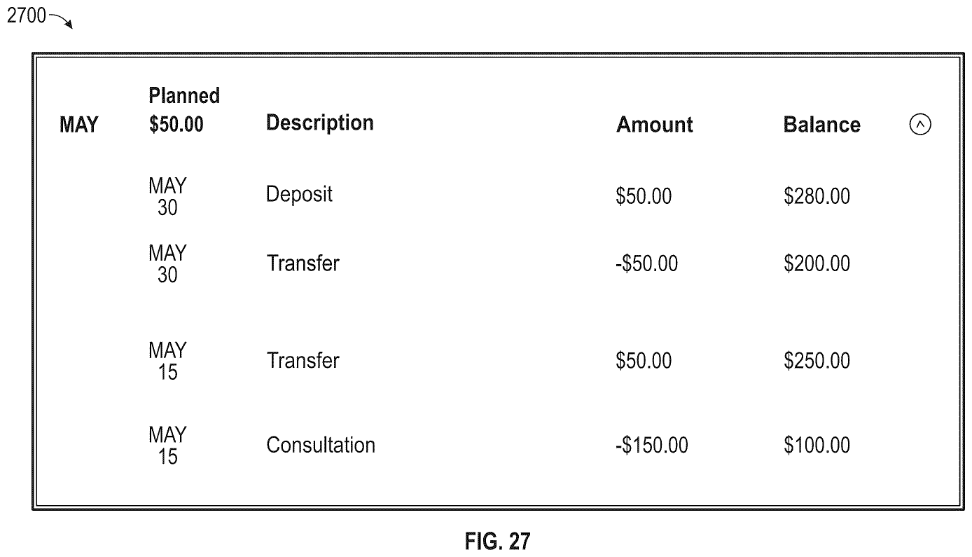

In another exemplary embodiment of a user living with their plan, the present technology provides a history of virtual account activity showing transfers into and out of the virtual account (history of virtual account cash flow and balance, including transfers) as shown in FIG. 27. For example, FIG. 27 depicts a Graphical User Interface (GUI) 2700 showing a history of virtual account activity showing transfers into and out of the virtual account, according to embodiments of the present technology.

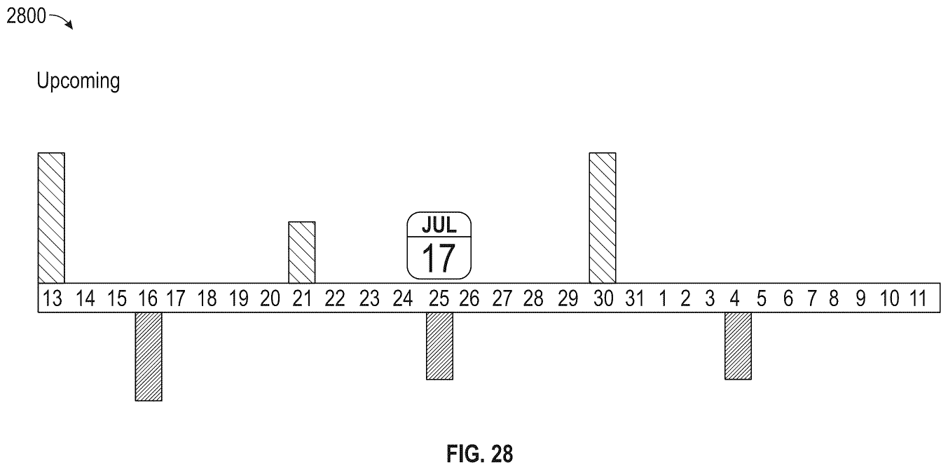

In another exemplary embodiment of a user living with their plan, the present technology provides past and projected future cash inflows and outflows, shown visually with upward bars with positive values for inflows and downward bars with negative values for outflows. For example, FIG. 28 depicts a Graphical User Interface (GUI) 2800 showing temporal context of virtual account activity including past and projected future cash inflows and outflows, according to embodiments of the present technology.

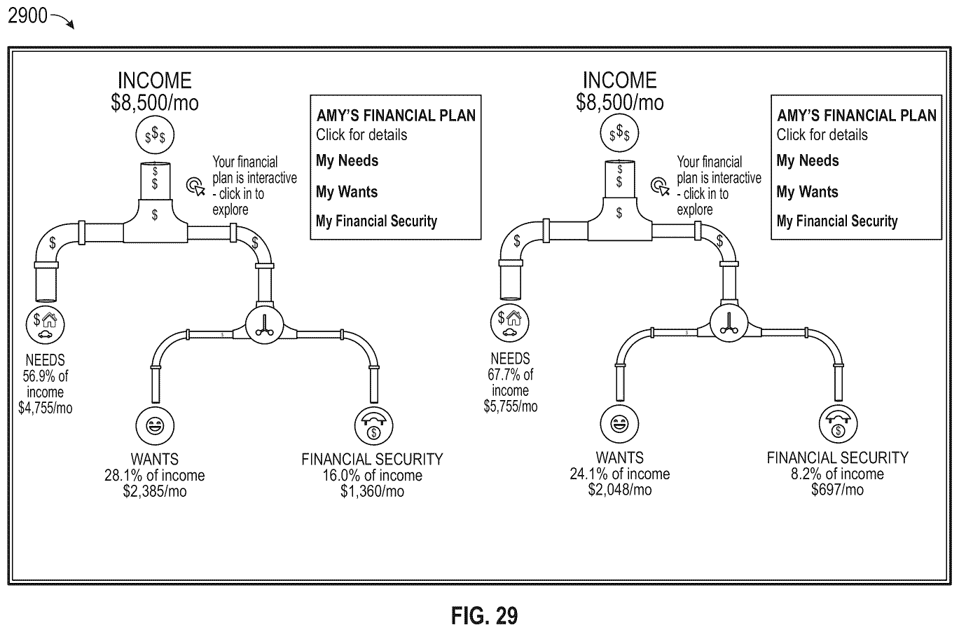

In another exemplary embodiment of a user living with their plan, the present technology provides re-optimization in response to change in one or more elements of user's financial life. For example, if the user has a rent increase or a large medical expense that depletes their emergency fund, the entire plan automatically rescales down to the most granular level (e.g. new dates to which emergency fund and Wants goals (e.g. a vacation) completion will get pushed out to). For example, FIG. 29 depicts a Graphical User Interface (GUI) 2900 showing re-optimization in response to change in one or more elements of user's financial life, according to embodiments of the present technology. For example, the Graphical User Interface (GUI) 2900 of FIG. 29 shows a re-optimization caused by a change in the cost of rent for a user resulting in the user's Needs increasing from 4,755 dollars per month to 5,755 dollars per month.

In another exemplary embodiment of a user living with their plan, the present technology provides alerts to bring relevant information or events to the user's attention.

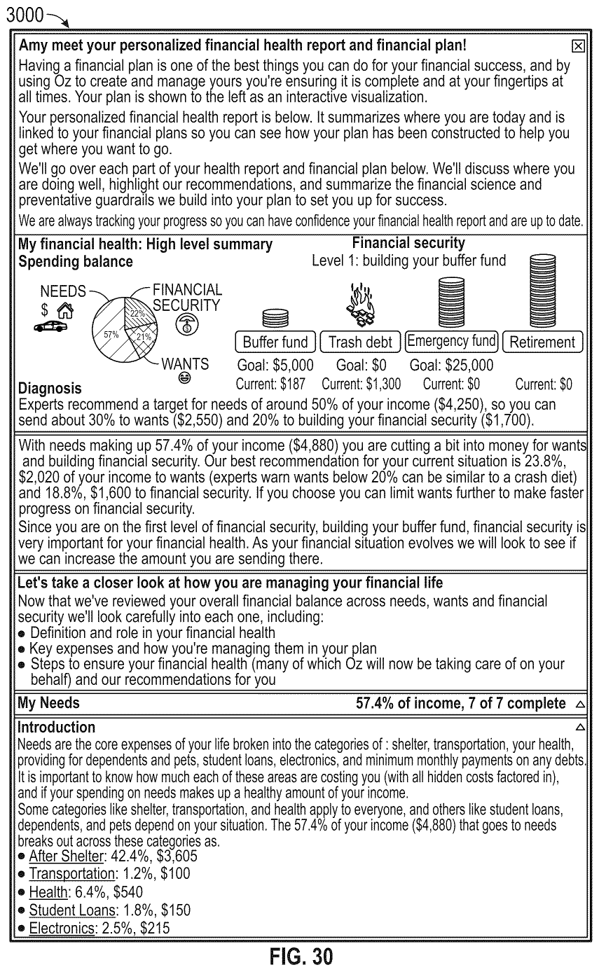

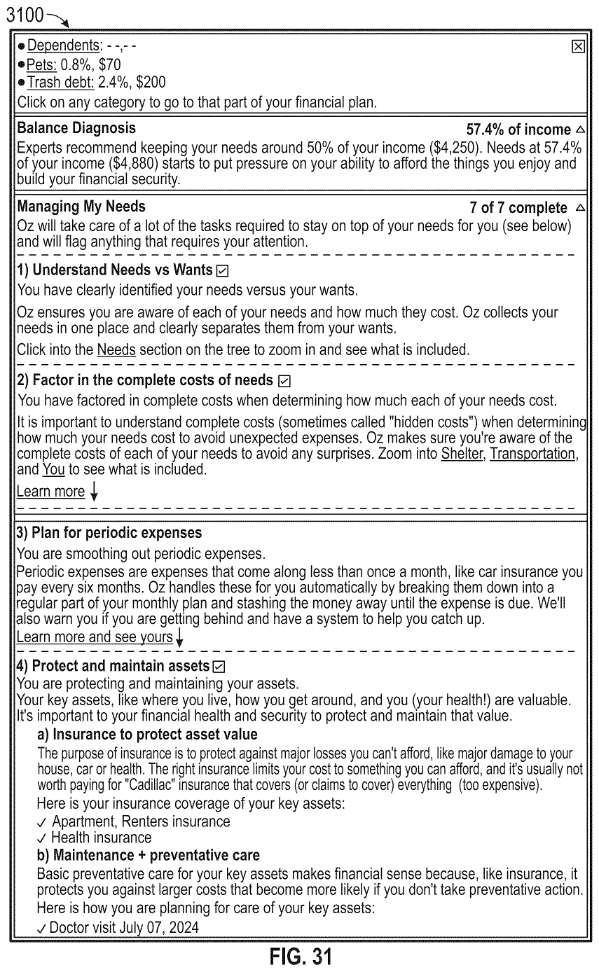

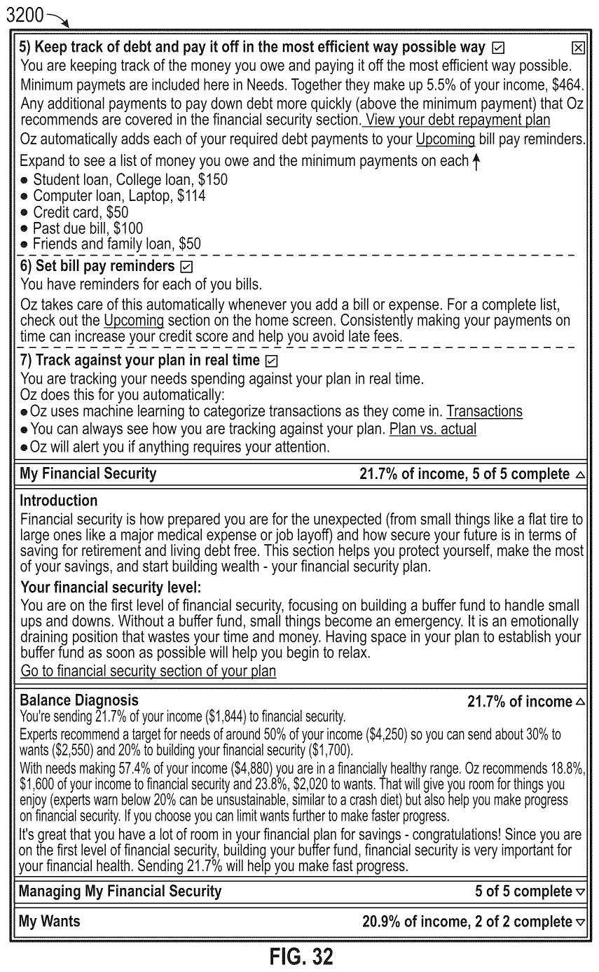

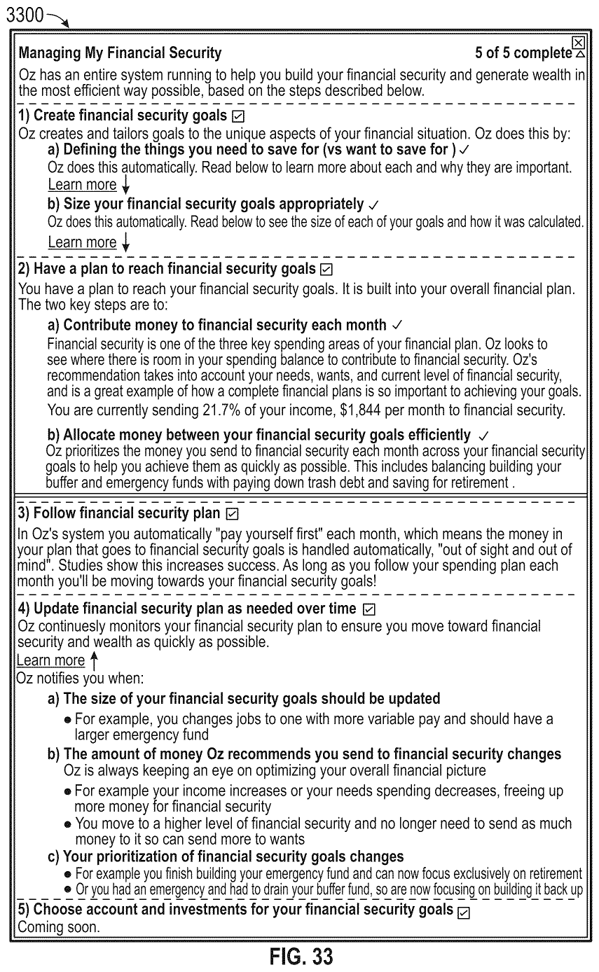

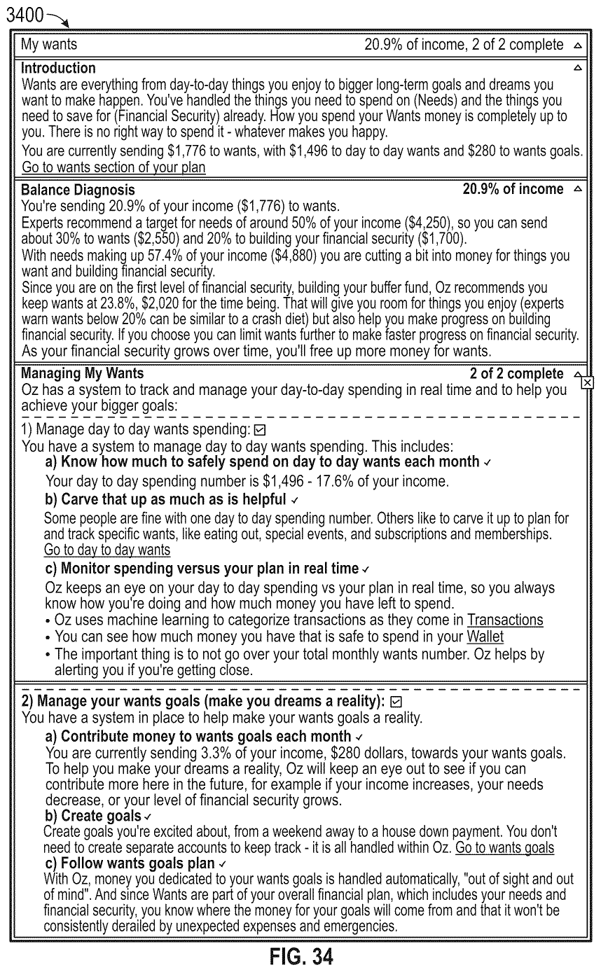

In an exemplary embodiment, the present technology provides a personalized financial health report of the user. For example, a financial health report of the user's financial life as shown in FIG. 30, FIG. 31, FIG. 32, FIG. 33, and FIG. 34. FIG. 30 depicts a Graphical User Interface (GUI) 3000 showing a financial health report of the user's financial life including a summary analysis of user's current financial situation, including diagnosis and recommended actions, according to embodiments of the present technology. FIG. 31 depicts a Graphical User Interface (GUI) 3100 showing further elements of the financial health report of the user's financial life including a summary analysis of user's current financial situation, including managing needs of the user, according to embodiments of the present technology. FIG. 32 depicts a Graphical User Interface (GUI) 3200 showing additional elements of the financial health report of the user's financial life including a summary analysis of user's current financial situation, including financial security of the user, according to embodiments of the present technology. FIG. 33 depicts a Graphical User Interface (GUI) 3300 showing elements of the financial health report of the user's financial life including a summary analysis of user's current financial situation, including managing financial security of the user, according to embodiments of the present technology. FIG. 34 depicts a Graphical User Interface (GUI) 3400 showing additional elements of the financial health report of the user's financial life including a summary analysis of user's current financial situation, including managing wants of the user, according to embodiments of the present technology. For example, a personalized financial health report of the user may include a detailed personalized text, data and graphics that provide a summary analysis of user's current financial situation, including diagnosis and recommended actions. The personalized financial health report of the user may summarize results of a scan for key risks (e.g. flags missing health or renter's insurance) and include personalized education for users interested in the financial science built into their plan. Furthermore, the personalized financial health report of the user may be continuously updated in response to changes in one or more elements of user's financial life, and in the optimization of their cash flow and balance sheet.

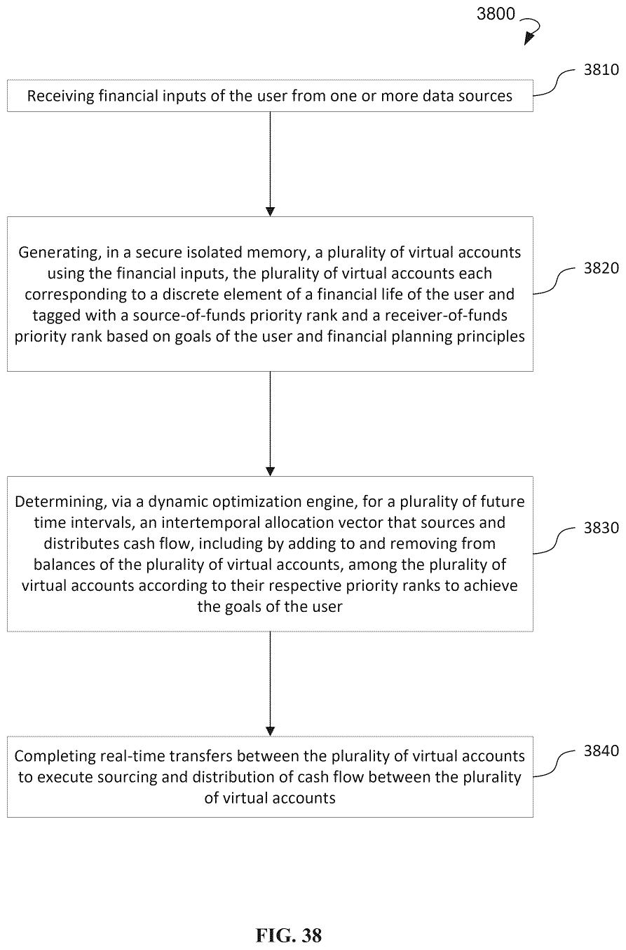

FIG. 38 describes a method for dynamic, intertemporal, priorities-based optimization of virtual accounts of a user, according to embodiments of the present technology. For example, FIG. 38 is a flowchart 3800 of an example method for a computer-implemented method for dynamic, intertemporal, priorities-based optimization of virtual accounts of a user according to various embodiments, the method comprising the following operations. At step 3810, receiving financial inputs of the user from one or more data sources. At step 3820 generating, in a secure isolated memory, a plurality of virtual accounts using the financial inputs, the plurality of virtual accounts each corresponding to a discrete element of a financial life of the user and tagged with a source-of-funds priority rank and a receiver-of-funds priority rank based on goals of the user and financial planning principles. At step 3830, determining, via a dynamic optimization engine, for a plurality of future time intervals, an intertemporal allocation vector that sources and distributes cash flow, including by adding to and removing from balances of the plurality of virtual accounts, among the plurality of virtual accounts according to their respective priority ranks to achieve the goals of the user. At step 3840, completing real-time transfers between the plurality of virtual accounts to execute sourcing and distribution of cash flow between the plurality of virtual accounts.

According to various embodiments, the method of FIG. 38 implements a computer-implemented system in which financial inputs are received from one or more data sources, including real-time transactional data and account balances imported via application programming interfaces. These inputs are used to instantiate a plurality of virtual accounts within a secure isolated memory, such as a hardware-based trusted execution environment, where each virtual account is mapped to a discrete element of the user's financial life. The secure isolated memory prohibits persistent storage of user-identifiable financial data outside the trusted execution environment, ensuring that all financial computations and data remain protected from external access.

According to various embodiments, each virtual account is assigned a source-of-funds priority rank and a receiver-of-funds priority rank, determined by applying a weighted scoring function based on user-defined importance metrics and principles of financial planning science. The virtual accounts are physically arranged in memory as distinct data structures, each tagged with metadata representing their priority ranks and financial attributes. This arrangement allows the system to model the flow of funds between accounts at sub-dollar granularity, supporting high-frequency updates and granular reallocation.

In some embodiments, the dynamic optimization engine 180, implemented as a software module operating within the secure isolated memory, continuously solves an intertemporal constrained optimization problem for a plurality of future time intervals. The dynamic optimization engine 180 computes an intertemporal allocation vector 155, which is a set of time-stamped allocation instructions for each virtual account, sourcing and distributing cash flow and reallocating virtual account balances according to the priority ranks. The optimization process incorporates hierarchical constraints to preserve previously satisfied higher-ranked priorities, ensuring that fundamental financial obligations are addressed before discretionary allocations are considered.

According to some embodiments, concrete technical effects attributable to the intertemporal allocation vector 155, include system-level improvements that arise from computing, storing, and updating the intertemporal allocation vector 155 within secure isolated memory and using it to drive real-time reallocation among virtual accounts. Reduced end-to-end latency for re-optimization and recommendation delivery. Maintaining a precomputed, time-stamped set of allocation instructions across future intervals eliminates repeated full-model re-computation on every micro-event. Incremental updates can be performed by selectively revising only affected time slices, reducing computation time and enabling near real-time UI updates. Lower computational load via incremental and hierarchical recalculation. The intertemporal allocation vector 155 provides a structured decomposition of the optimization across discrete future intervals and priority tiers. Perturbations (e.g., a new transaction) trigger localized constraint propagation and partial re-solving for impacted intervals, reducing the number of solver iterations and overall CPU cycles compared to monolithic re-solves. Enhanced throughput and responsiveness under streaming inputs. Because the intertemporal allocation vector 155 represents a forward schedule of source-and-receiver flows, the system can apply event-driven deltas to the schedule rather than initiating full-pipeline analyses. This improves throughput when processing bursts of transactions and supports sub-second feedback to the UI. Improved numerical stability and constraint preservation over time. Encoding hierarchical priority constraints directly into the intertemporal allocation vector 155 for each future interval preserves previously satisfied higher-ranked obligations during re-optimization. This mitigates oscillations and constraint thrashing across cycles, improving convergence behavior and stability of results. Predictive capability with time-indexed projections. The intertemporal allocation vector 155 enables deterministic projections of virtual account balances by interval, allowing precomputation of path-dependent outcomes and early detection of shortfalls or deadline risks, which supports proactive alerting and pre-emptive sourcing decisions with reduced lookahead re-computation. Faster UI rendering and smoother animations. The intertemporal allocation vector 155 provides a ready-to-render timetable of flows and balances. The visualization module can stream these values to drive animations and resizing without invoking the solver, reducing frame drops and improving user-perceived responsiveness. Reduced dependency on external synchronization cycles. Because forward allocations are computed and stored internally, the system can advance the plan immediately upon receiving local events, and only reconcile with external custodial data asynchronously. This decoupling reduces blocking I/O and improves overall system availability. Seamless alignment of cash flow and balance-sheet adjustments. The intertemporal allocation vector 155 encodes coordinated instructions to source cash flow and adjust virtual balances over time, ensuring synchronized updates across both dimensions with fewer reconciliation passes and reduced data races between modules.

According to some embodiments, upon receiving updated financial inputs in real-time, such as new transactions, changes to assets or liabilities, or updates to user goals, the system automatically re-optimizes the intertemporal allocation vector 155 within the secure isolated memory. This enables immediate recalculation of allocations and projections of future cash flow and virtual account balances, without the latency associated with synchronizing the external custodial accounts 190.

According to some embodiments, the dynamic virtual representation module renders a graphical depiction of the plurality of virtual accounts 170 and the intertemporal allocation vector 155. Each virtual account is represented as a graphical element, such as a circle, pipe, or bar, whose size dynamically scales with the amount of funds allocated. The module animates cash-flow paths among these elements and resizes them in real-time in response to user adjustments of priority ranks or allocations. Interactive zoom functionality allows users to transition from aggregate views of spending groupings (e.g., Needs, Wants, Financial Security) down to individual virtual account line items, as shown in FIG. 15 through FIG. 20.

According to various embodiments, the user interface provides personalized feedback and recommendations for financial actions, including prioritized sets of recommended transactions such as adjusting discretionary spending, redirecting funds toward savings goals, making additional payments to reduce high-interest debt, or transferring funds between external custodial accounts. Visual levers and controls within the interface allow users to incrementally adjust allocations to specific financial goals and immediately view the impact on the virtual accounts, supporting scenario simulations and real-time decision-making.

Historical intertemporal allocation vectors and corresponding user interactions are stored within the secure isolated memory for back-testing and performance analytics, enabling users to analyze past decisions and outcomes. The system also generates alerts to notify users of risks associated with the user's failure to execute one or more actions recommended by the optimization, such as approaching payment deadlines, based on analysis of the virtual accounts.

For example, as illustrated in FIG. 29, the system automatically re-optimizes and visually rescales the virtual representation in response to a change in the user's financial life, such as a rent increase, updating all relevant allocations and projections in real-time. This technical arrangement enables continuous, high-frequency re-optimization and visualization of financial plans, supporting granular, real-time financial decision-making and enhanced data security, which are not achievable with conventional financial management systems.

In some embodiments the receiving inputs comprises automatically importing real-time transactional data and account balance information from at least one linked external custodial account through an application programming interface. In various embodiments, the receiving of inputs for the system may involve different methods and configurations to ensure seamless integration with external custodial accounts. For instance, in one embodiment, the system may utilize an application programming interface (API) to automatically import real-time transactional data and account balance information from linked financial accounts, such as checking accounts, savings accounts, credit cards, and investment portfolios. In another embodiment, the system may employ secure data aggregation services that consolidate financial data from multiple institutions, ensuring compatibility with diverse banking systems and formats. Additionally, the receiving process may include user-provided inputs, such as manual entry of financial details or uploading of documents like pay stubs, tax returns, or expense reports, to supplement automated data collection. In yet another embodiment, the system may integrate with third-party financial tools or platforms, such as budgeting apps or payroll systems, to retrieve relevant financial data. Furthermore, the system may incorporate advanced security protocols, such as encryption and tokenization, to protect sensitive financial information during data capture and transmission. These embodiments collectively ensure that the system can adapt to various user scenarios and data sources while maintaining accuracy, security, and efficiency.

In some embodiments the plurality of virtual accounts 170 comprise virtual accounts for income sources, spending categories classified as needs, spending categories classified as wants, savings for financial security, assets, and liabilities, the plurality of virtual accounts 170 having both a source-of-funds and receiver-of-funds priority rank. In different embodiments, the plurality of virtual accounts 170 may be configured to represent a wide range of financial elements, including but not limited to income sources, spending categories classified as needs, spending categories classified as wants, savings for financial security, assets, and liabilities. For example, one embodiment may include virtual accounts for multiple types of income, such as salary, freelance payments, investment returns, or government benefits, each with distinct priority ranks. Another embodiment may feature granular virtual accounts for needs, such as shelter, health, transportation, and food, with each account assigned both a source-of-funds-priority rank and a receiver-of-funds-priority rank that can be dynamically adjusted based on user preferences or financial planning principles. In yet another embodiment, virtual accounts for wants may be subdivided into day-to-day discretionary spending and long-term wants goals, allowing users to allocate funds to specific activities or savings targets. The system may also support virtual accounts for various asset classes, such as cash, securities, real estate, and retirement accounts, as well as liabilities including credit card debt, loans, and mortgages. Each virtual account may be implemented as a secure, isolated data structure within memory, tagged with metadata for priority ranking and financial attributes, and capable of real-time updates and reallocation in response to changes in user inputs or financial circumstances.

In some embodiments the determining the dynamic, intertemporal, priorities-based optimization comprises solving, an intertemporal constrained optimization problem that maximizes a weighted aggregate of user goal-attainment scores subject to the source-of-funds priority rank and the receiver-of-funds priority rank for the plurality of virtual accounts 170. In various embodiments, the determination of dynamic, intertemporal, priorities-based optimization may be achieved through different approaches to solving an intertemporal constrained optimization problem that maximizes a weighted aggregate of user goal-attainment scores. For example, one embodiment may utilize a optimization algorithm that continuously updates allocations as new financial data is received, ensuring that both source-of-funds and receiver-of-funds priority ranks for each virtual account are respected. Another embodiment may employ a batch processing method, where optimization is performed at predefined intervals, such as daily, weekly, or monthly, to accommodate user preferences for update frequency. In yet another embodiment, the system may incorporate machine learning models to refine the weighting of goal-attainment scores based on historical user behavior and outcomes, thereby personalizing the optimization process. The optimization engine may also support hierarchical constraints, ensuring that higher-ranked priorities are satisfied before allocating resources to lower-ranked accounts. These embodiments allow for flexible, adaptive, and personalized optimization of cash flow and management of assets and liabilities across a diverse set of financial scenarios.

In some embodiments the dynamic optimization engine 180 is configured to preserve previously satisfied higher-ranked priorities by imposing hierarchical constraints during each re-optimization cycle. For example, one embodiment may implement a rule-based system that preserves allocations to virtual accounts associated with necessary needs or high-priority financial obligations, ensuring that these allocations remain unchanged unless a significant change in user circumstances is detected. Another embodiment may utilize a tiered constraint model, where satisfied priorities are maintained at their current levels while lower-ranked priorities are dynamically adjusted in response to new financial inputs or changes in user goals. In yet another embodiment, the engine may employ a historical tracking mechanism that references past optimization cycles to prevent regression in the satisfaction of high-ranking priorities, thereby maintaining continuity in financial planning. These embodiments provide robust mechanisms for safeguarding the fulfillment of primary financial objectives while allowing for adaptive reallocation among less significant accounts.

In some embodiments the providing the personalized feedback comprises generating a prioritized set of recommended real-world transactions that include one or more of adjusting discretionary spending or spending on needs, redirecting funds to or from a savings goal, making an additional payment to reduce debt, increasing one or more forms of debt, or transferring funds between external custodial accounts 190. In various embodiments, the system may generate personalized feedback by producing a prioritized set of recommended real-world transactions tailored to the user's financial situation. For example, one embodiment may recommend adjusting discretionary spending by suggesting reductions in specific spending categories when cash flow is constrained. Another embodiment may redirect funds toward a savings goal, such as increasing contributions to an emergency fund or retirement account based on updated priorities or financial events. In yet another embodiment, the system may advise making an additional payment to reduce high-interest debt, identifying optimal payment amounts and timing to maximize interest savings. Additionally, the system may recommend transferring funds between external custodial accounts 190, such as moving surplus funds from a checking account to a high-yield savings account or brokerage account to improve financial outcomes. These embodiments enable the system to provide actionable, context-specific recommendations that help users balance competing priorities and achieve their financial goals.

In some embodiments the dynamic virtual representation comprises an interactive graphical user interface that: depicts the plurality of virtual accounts 170 as a visual element whose size scales with an amount of funds allocated to the plurality of virtual accounts 170; animates cash-flow paths among the visual elements in accordance with the optimization; and resizes the visual elements in real-time in response to a user adjustment of any priority rank and the recalculation of the intertemporal allocation vector 155 the user's adjustment triggers. In some embodiments, the dynamic virtual representation may comprise an interactive graphical user interface that visually depicts the plurality of virtual accounts 170 as a distinct visual element, such as a circle, pipe, or bar, whose size scales with the amount of funds allocated thereto or balance thereof. The interface may animate cash-flow paths among these visual elements in accordance with the underlying optimization, providing users with an intuitive understanding of how resources are distributed. In another embodiment, the graphical user interface may dynamically resize the visual elements in real-time in response to a user adjustment of any priority rank, immediately reflecting the impact of such changes on the overall financial plan. Additional embodiments may include interactive controls, such as sliders or levers, enabling users to incrementally adjust one or more inputs and observe the resulting re-optimization and visual rescaling of all affected elements. The graphical user interface may be implemented for various device types, including desktop computers, tablets, and mobile phones, and may support features such as zooming into specific account categories or viewing historical trends, thereby enhancing user engagement and decision-making.

In some embodiments the intertemporal allocation vector 155 is computed for user-defined periodic intervals and is automatically updated at each interval boundary. In various embodiments, the intertemporal allocation vector 155 may be computed for user-defined periodic intervals and automatically updated at each interval boundary to reflect changes in financial inputs or user priorities. For example, one embodiment may allow users to select intervals such as daily, weekly, monthly, or custom periods, with the system recalculating allocations at the end of each interval to ensure optimal distribution of cash flow among virtual accounts. Another embodiment may feature continuous monitoring of financial data, triggering interval updates whenever significant transactions or changes in assets and liabilities are detected. In yet another embodiment, the system may provide flexibility for users to adjust interval settings based on their financial planning needs, such as aligning updates with pay cycles or recurring expenses. These embodiments enable adaptive, timely optimization of personal cash flow and balance sheet management, supporting both routine and event-driven financial decision-making.

Some embodiments further comprise storing, within the secure isolated memory, historical intertemporal allocation vectors and corresponding user interactions for back-testing and performance analytics. In some embodiments, historical intertemporal allocation vectors and corresponding user interactions may be stored within the secure isolated memory for back-testing and performance analytics. For example, one embodiment may maintain a detailed log of all allocation vectors and user adjustments, enabling retrospective analysis of financial decisions and outcomes over time. Another embodiment may aggregate historical data to generate performance reports, trend visualizations, or predictive analytics that help users understand the long-term impact of their financial choices. In yet another embodiment, the system may allow users to compare different periods or scenarios, facilitating informed decision-making and continuous improvement of financial strategies. These embodiments support robust data-driven insights and enhance the transparency and effectiveness of the optimization process.

In some embodiments rendering the graphical depiction includes providing interactive zoom functionality to transition from an aggregate view of spending groupings down to individual virtual account line items. For example, one embodiment may allow users to click or tap on a high-level category, such as Needs, Wants, or Financial Security, to expand and reveal sub-categories or specific virtual accounts within that grouping. Another embodiment may support pinch-to-zoom gestures on touch-enabled devices, enabling users to smoothly navigate between summary views and detailed breakdowns of their financial allocations. In yet another embodiment, the system may offer hierarchical navigation controls, such as breadcrumb trails or expandable lists, to facilitate intuitive exploration of financial data at varying levels of granularity. These embodiments enhance user understanding and engagement by allowing flexible, context-sensitive visualization of both aggregate and detailed financial information.

Some embodiments further comprise generating, via the dynamic virtual representation module, a scenario simulation that projects adjustments to the intertemporal allocation vector 155 in response to hypothetical user modifications of one or more priority ranks. In some embodiments, the system may generate scenario simulations via the dynamic virtual representation module that project adjustments to the intertemporal allocation vector 155 in response to hypothetical user modifications of one or more priority ranks. For example, one embodiment may allow users to adjust the priority rank of a specific virtual account and immediately visualize the projected impact on future cash flow allocations and goal achievement timelines. Another embodiment may enable users to create multiple hypothetical scenarios, such as increasing savings for retirement or reducing discretionary spending, and compare the outcomes side-by-side within the interface. In yet another embodiment, the system may provide automated recommendations for optimal adjustments based on simulated scenarios, helping users evaluate trade-offs and make informed financial decisions. These embodiments facilitate proactive financial planning and empower users to explore the consequences of potential changes before taking real-world actions.

In some embodiments each source-of-funds priority rank and receiver-of-funds priority rank is determined by applying a weighted scoring function based on user-defined importance metrics and principles of financial planning science. For example, one embodiment may allow users to assign custom importance values to different financial goals, which are then combined with standardized financial planning guidelines to calculate priority ranks for each virtual account. Another embodiment may utilize an adaptive scoring algorithm that dynamically adjusts weights based on changes in user behavior, financial circumstances, or market conditions. In yet another embodiment, the system may incorporate demographic factors, such as age, location, or income level, into the scoring function to further personalize priority rankings. These embodiments enable flexible, data-driven determination of priority ranks, supporting highly individualized and scientifically informed financial optimization.

In some embodiments the graphical depiction includes visual levers that allow the user to incrementally adjust allocations to specific financial goals and immediately view an impact on the plurality of virtual accounts 170. In some embodiments, the graphical depiction may include visual levers that allow the user to incrementally adjust allocations to specific financial goals and immediately view an impact on the plurality of virtual accounts 170. For example, one embodiment may feature plus and minus buttons adjacent to each financial goal, enabling users to increase or decrease the allocation of funds interactively. Another embodiment may utilize slider controls that provide fine-grained adjustment of allocations, with real-time visual feedback showing how changes affect the size and status of related virtual accounts, and the user's overall intertemporal allocation vector. In yet another embodiment, the system may offer drag-and-drop functionality, allowing users to reallocate funds between goals by moving graphical elements within the interface. These embodiments enhance user engagement and decision-making by providing intuitive, immediate visualization of the effects of allocation adjustments across the user's financial plan.

In some embodiments the method further comprises generating alerts to notify the user of risks, based on analysis of the plurality of virtual accounts 170, the risks including approaching payment deadlines. For example, one embodiment may provide real-time notifications when a scheduled payment is due soon, helping users avoid late fees or missed obligations. Another embodiment may analyze spending patterns and alert users to potential shortfalls in specific virtual accounts, such as insufficient funds for upcoming bills or savings goals. In yet another embodiment, the system may issue warnings about unusual account activity, changes in financial health indicators, or emerging risks related to asset or liability balances. These embodiments support proactive financial management by keeping users informed of significant events and enabling timely corrective actions.

In some embodiments the intertemporal allocation vector 155 is computed for a plurality of future time intervals and dynamically distributes cash flow and reallocates balances among the plurality of virtual accounts 170 according to their respective priority ranks to optimize achievement of the user's financial goals over time. In some embodiments, the intertemporal allocation vector 155 may be computed for a plurality of future time intervals and dynamically distribute cash flow among the plurality of virtual accounts 170 according to their respective priority ranks to optimize achievement of the user's financial goals over time. For example, one embodiment may calculate allocation instructions for daily, weekly, monthly, or custom future intervals, allowing users to project and adjust their financial plans across short-term and long-term horizons. Another embodiment may enable the system to automatically update the allocation vector in response to anticipated changes in income, expenses, or user priorities, ensuring that the distribution of funds remains optimal as circumstances evolve. In yet another embodiment, the system may provide visualizations of projected cash flow and balance sheet changes for each interval, supporting forward-looking financial planning and scenario analysis. These embodiments facilitate continuous, adaptive optimization of personal finances over multiple timeframes.

In some embodiments the intertemporal allocation vector 155 comprises a set of time-stamped allocation instructions for the plurality of virtual accounts 170, enabling forward-looking projections of cash flow and balance sheet changes. In some embodiments, the intertemporal allocation vector 155 may comprise a set of time-stamped allocation instructions for the plurality of virtual accounts 170, enabling forward-looking projections of cash flow and balance sheet changes. For example, one embodiment may generate allocation instructions that specify the amount and timing of funds to be distributed to each virtual account over a series of future intervals, such as daily, weekly, or monthly. Another embodiment may allow users to customize the time intervals and allocation parameters to align with specific financial goals or events, such as upcoming bill payments, savings milestones, or investment opportunities. In yet another embodiment, the system may provide automated updates to the allocation instructions in response to changes in user inputs, financial transactions, or evolving priorities, ensuring that projections remain accurate and actionable. These embodiments support detailed, time-based financial planning and enable users to anticipate and manage future cash flow and balance sheet developments with precision.

In some embodiments the intertemporal allocation vector 155 is automatically updated in response to changes in the user's financial inputs, including new transactions, modifications to assets or liabilities, updates to user goals and priorities, or other elements of the user's financial life. In some embodiments, the intertemporal allocation vector 155 may be automatically updated in response to changes in the user's financial inputs, including new transactions, modifications to assets or liabilities, updates to user goals and priorities, or other elements of the user's financial life. For example, one embodiment may feature real-time monitoring of linked financial accounts and user activity, triggering immediate recalculation of allocations whenever a new transaction is detected or account balance changes. Another embodiment may allow users to manually input changes, such as adjustments to asset values or the addition of new liabilities, prompting the system to re-optimize the allocation vector accordingly. In yet another embodiment, the system may integrate with external data sources to receive updates on market conditions or interest rates, dynamically adjusting allocations to reflect the prevailing financial environment. These embodiments ensure that the optimization remains current and responsive to the user's evolving financial circumstances.

For purposes of this disclosure of the present technology, the following terms shall have the meanings set forth below unless the context clearly indicates otherwise.

As used herein, “financial inputs” refers to data representing a user's financial life ingested by the system, including real-time transactional records, income and payroll information, recurring and ad hoc expense data, current and historical account balances, asset holdings and valuations, liabilities and loan terms (including interest rates, due dates, fees, and payment histories), insurance coverage details, user-defined goals and priorities, and demographic or contextual factors; such data may be received via application programming interfaces, secure data aggregation services, direct user entry, or document uploads, and is validated and normalized at ingress within secure isolated memory for use by the dynamic optimization engine.

As used herein, “real-time” refers to system operation in which validated financial inputs and user interactions are processed and reflected in the intertemporal allocation vector and corresponding virtual account states with end-to-end latency sufficiently low to support immediate decision-making and interface updates, typically on the order of sub-second to a few seconds, without reliance on batch synchronization with external custodial accounts.

As used herein, “secure isolated memory” refers to a hardware-based trusted execution environment that confines execution and storage of sensitive financial computations and data to protected memory regions, prohibits persistent storage of user-identifiable financial data outside the trusted execution environment, and enforces encrypted ingress and egress for data exchanges.

As used herein, a “virtual account” refers to a secure, in-memory data structure instantiated within the secure isolated memory that corresponds to a discrete element of a user's financial life, including by way of example an income source, a spending category, an asset, or a liability, and that maintains metadata including current balance, projected balance, a source-of-funds priority rank, and a receiver-of-funds priority rank. For example, a virtual account is one of the plurality of virtual accounts 170.

As used herein, a “source-of-funds priority rank” refers to a numeric or ordinal priority value assigned to a virtual account indicating its relative desirability or precedence as a source from which funds may be drawn in the optimization, the value being computed by a weighted scoring function based on user-defined importance metrics and principles of financial planning science.

As used herein, a “receiver-of-funds priority rank” refers to a numeric or ordinal priority value assigned to a virtual account indicating its relative desirability or precedence as a destination to which funds may be allocated in the optimization, the value being computed by a weighted scoring function based on user-defined importance metrics and principles of financial planning science.

As used herein, a “weighted scoring function” refers to a function that maps user-defined importance metrics, demographic factors, including factors identified based on analysis of the user's actions and performance over time and/or of the actions and performance of a broader set of users collected by the system, and principles of financial planning science into a scalar priority value, optionally normalized across accounts, used to determine source-of-funds and receiver-of-funds priority ranks.

As used herein, a “dynamic optimization engine” refers to a software module executing within the secure isolated memory that solves an intertemporal constrained optimization problem over a plurality of future intervals using the current state of virtual accounts, their priority ranks, and constraints, and that produces event-driven updates upon changes to financial inputs. For example, the dynamic optimization engine 180.

As used herein, an “intertemporal allocation vector” refers to a set of time-stamped allocation records stored within the secure isolated memory, each record specifying, for a given virtual account and future interval, an instruction comprising an amount, timing, and directive type, including source or distribution of cash flow and add or remove from balance directives, which are used to coordinate cash-flow sourcing and distribution and balance reallocations over time.

As used herein, “hierarchical constraints” refers to constraint rules encoded in the optimization that preserve previously satisfied higher-ranked priorities across re-optimization cycles and enforce precedence relationships among virtual accounts, including by way of example needs before wants and minimum obligations before discretionary allocations.

As used herein, an “application programming interface (API) call” refers to a request or response message carrying financial input data to the system, validated and normalized at ingress within the secure isolated memory, and mapped to discrete events including new transactions, balance updates, or goal changes that trigger interval-local updates to the intertemporal allocation vector.

As used herein, “event-driven incremental re-optimization” refers to a re-optimization method in which receipt of a validated event causes localized recalculation of only the affected time intervals and accounts in the intertemporal allocation vector, with constraint propagation limited to impacted subsets, thereby reducing solver iterations and latency.

As used herein, a “scenario simulation” refers to a versioned set of intertemporal allocation vectors representing alternative future conditions or hypothetical user modifications, including priority changes, computed within the secure isolated memory and used to project impacts on allocations, balances, and goal timelines.

As used herein, a “dynamic virtual representation” or “dynamic virtual representation module” refers to a graphical interface component that renders, from the intertemporal allocation vector, visual elements corresponding to virtual accounts whose sizes scale with funds allocated or balances, animates cash-flow paths among elements, and resizes elements in real-time in response to user adjustments or updated financial data.

As used herein, “discretionary cash flow” refers to the portion of income remaining after allocations to needs and minimum required obligations, available for distribution between wants and financial security sub-areas according to the optimization and user preferences.

As used herein, a “financial security level” or “financial security score” refers to a computed indicator derived from savings levels, high-interest debt amounts, buffer or emergency fund status, and retirement savings, used by the optimization to guide allocations among financial security sub-areas including buffer fund, high-interest debt repayment, emergency fund, and retirement, and prioritization of allocations across virtual accounts more broadly.

As used herein, a “directive type” refers to a classification field in an intertemporal allocation record indicating the nature of the instruction, including source of funds, receiver of funds, balance increment, balance decrement, and payment directive.

As used herein, an “interval-local update” refers to a modification applied to one or more records in the intertemporal allocation vector confined to specific future time intervals identified as impacted by an event, without recomputing unaffected intervals.

As used herein, “personalized feedback” refers to a prioritized set of recommended user actions and transactions, explanations, educational content, and interactive responses to user questions generated from the current intertemporal allocation vector, including adjusting spending, redirecting funds to savings, making additional payments to reduce debt, and executing transfers between external custodial accounts, delivered via the dynamic virtual representation.

As used herein, an “external custodial account” refers to a financial institution account maintained outside the system, including checking, savings, credit card, loan, and brokerage accounts, optionally linked via secure application programming interfaces to provide transactional and balance data, wherein synchronization with such accounts is decoupled from real-time optimization performed in the secure isolated memory.

As used herein, “back-testing and performance analytics” refers to analyses performed within the secure isolated memory using stored historical intertemporal allocation vectors and user interactions to reconstruct decisions, measure outcomes, and evaluate optimization performance over time.

As used herein, “visual levers” refers to interactive controls within the dynamic virtual representation, including sliders and plus or minus buttons, that allow users to adjust priorities or allocations and immediately observe the re-computed impact across virtual accounts and intervals.

As used herein, a “payment deadline constraint” refers to a constraint ensuring that payment directives for liabilities in the intertemporal allocation vector align with due dates, minimizing late-payment risk and triggering alerts when shortfalls are predicted.

As used herein, “dynamic, intertemporal, priorities-based optimization” refers to a computer-implemented process that, over a plurality of future time intervals, continuously computes and updates allocation decisions for sourcing and distributing cash flow and adjusting virtual account balances based on prioritized objectives. The optimization operates on virtual accounts within secure isolated memory, encodes user-defined priorities and principles of financial planning as source-of-funds and receiver-of-funds, and solves an intertemporal constrained optimization that maximizes a weighted aggregate of goal-attainment scores subject to budget, precedence, hierarchical, and payment deadline constraints. The process is event-driven and incremental, re-optimizing only affected intervals and accounts upon receipt of validated updates to financial inputs, thereby preserving previously satisfied higher-ranked obligations and producing a time-stamped intertemporal allocation vector that coordinates cash-flow and balance-sheet adjustments across time.

These definitions are intended to clarify claim scope and provide antecedent basis. Where examples are provided, they are exemplary and non-limiting.

In one embodiment, the dynamic optimization engine computes the intertemporal allocation vector by solving an intertemporal constrained optimization over N virtual accounts across T future intervals, maximizing a weighted aggregate of user goal-attainment scores subject to source-of-funds priority rank and receiver-of-funds priority rank.

Let i∈{1, . . . , N} index virtual accounts and t∈{1, . . . , T} index discrete future intervals (e.g., weeks). Let x_{i,t} denote the allocation decision to account i at interval t (positive values allocate funds to the account; negative values source funds from the account). Let B_{i,t} denote the projected end-of-interval balance of account i, and I_t denote net income available for allocation in interval t. Each account i is assigned a receiver-of-funds priority rank R_i and a source-of-funds priority rank S_i based on a weighted scoring function that combines user-defined importance metrics and financial planning principles. Let w_i be a user importance weight for account i, and let g_i(B_{i,t})∈[0,1] be a goal-attainment score as a function of the projected balance.

### Objective:

$${max}_{\{ {x}_{i , t} , {B}_{i , t} \}} {Σ}_{t = 1}^{T} {Σ}_{i = 1}^{N} {w}_{i} {ℊ}_{i} ( {B}_{i , t} )$$

### Balance Evolution:

$${B}_{i , t} = {B}_{i , t - 1} + {x}_{i , t} + {η}_{i , t}$$

where η_{i,t} captures exogenous effects (e.g., interest accrual for debt, appreciation of asset balance).

### Budget Constraint Per Interval:

$${Σ}_{i = 1}^{N} {x}_{i , t} \leq {I}_{t}$$

Receiver-of-funds priority constraints (fund high R_i first up to needs/targets): For each interval t, define per-account caps U_{i,t} and tier budgets Y_{k,t} for receiver tiers k. Enforce:
0≤x_{i,t}≤U_{i,t} if account i is active at t

$${\sum }_{i : {R}_{i} ∈ tier k} {x}_{i , t} \leq {Y}_{k , t}$$

with tier activation in descending R_i order such that higher-tier minimum obligations are satisfied before lower tiers receive allocations. A compact encoding:

$${\sum }_{i : {R}_{i} \geq {r}^{⋆}} \qquad {x}_{i , t} \geq {Θ}_{t} ( {r}^{⋆} )$$

Source-of-funds priority constraints. Higher Sᵢ indicates lower preference to source funds from account i (limit sourcing from high Sᵢ to preserve priorities): For sourcing (negative x_{i,t}), impose rank-sensitive limits:

$${x}_{i , t} \geq - {L}_{i , t} , {L}_{i , t} = {λ}_{i} \cdot \{ {S}_{i} \geq {s}^{⋆} \}$$

and protect balances of high source-rank accounts:

$${B}_{i , t} \geq {B}_{i , t}^{min} for all i with {S}_{i} \geq {s}^{protect}$$

Hierarchical constraints (preserve satisfied obligations across intervals): If a high-priority obligation was satisfied in a prior interval, maintain it forward:

$${B}_{i , t} \geq {B}_{i , t}^{oblig} for ( i , t ) ∈ ℋ$$

Payment deadline constraints for liabilities: Ensure cumulative payments meet due dates:

$${\sum }_{τ = 1}^{{t}_{d}} \qquad {x}_{i , τ} \geq {P}_{i , {t}_{d}} for liability i due at {t}_{d}$$

Needs-before-wants sequencing: Partition accounts into needs N, financial security F, and wants [symbol] :

$${\sum }_{i ∈ 𝒩} {x}_{i , t} \geq {N}_{t}^{min}$$

$${\sum }_{i ∈ ℱ} {x}_{i , t} \geq {F}_{t}^{min} after {N}_{t}^{min} is met$$

$${\sum }_{i ∈ 𝒲} {x}_{i , t} \leq {I}_{t} - {N}_{t}^{min} - {F}_{t}^{min}$$

Illustrative numeric scenario: Consider four virtual accounts over two monthly intervals (T=2):
i=1 Rent (need; high receiver rank), target minimum per month U_{1,t}=$2,000.
i=2 Emergency Fund (financial security; high receiver rank), planned contribution U_{2,t}=$400.
i=3 Credit Card (liability; high receiver rank for payment; protected as a source), payment deadline at t=2 with P_{3,2}=$500.
i=4 Dining Out (want; low receiver rank), unconstrained up to remaining budget.

Income: I_1=$4,000, I_2=$4,000. Needs minimum:

$${N}_{t}^{min} = \$2 , 000 ( rent ) .$$

Financial security minimum:

$${F}_{t}^{min} = \$ 300$$

(at least the minimum que plus buffer contributions).

A feasible optimal solution the engine may produce:
Interval 1: x_{1,1}-$2,000 (rent), x_{2,1}-$400 (emergency fund), x_{3,1}=$300 (credit card payment toward deadline), x_{4,1}=$1,300 (dining out).
Interval 2: x_{1,2}-$2,000, x_{2,2}=$400, x_{3,2}-$200 (meets cumulative P_{3,2}-$500), x_{4,2}=1,400.

The optimization respects receiver ranks by funding rent and debt obligations before wants, and respects source ranks by disallowing sourcing from protected accounts. The resulting allocation decisions x_{i,t} are written into the intertemporal allocation vector as time-stamped directives for each account and interval, enabling forward projections of balances B_{i,t} and driving the dynamic virtual representation.

Event-driven incremental update: If a new medical bill of $300 is received at t=1 via a validated API event, the engine identifies impacted sets [symbol] ={Rent, Emergency Fund, Credit Card, Dining Out} and intervals [symbol] ={1,2}, and solves a localized subproblem to reallocate the shortfall while preserving satisfied higher-ranked obligations. For example, the updated solution may reduce both x_{4,1} and x_{4,2} to $1,200, thereby sourcing $300 to cover the $300 expense, while maintaining the credit card payment deadline and without violating protected receiver and source constraints. The amended directives are committed to the intertemporal allocation vector with updated timestamps, and the user interface resizes elements in real time without invoking a full re-computation across unaffected intervals.

Example of each source-of-funds priority rank and receiver-of-funds priority rank is determined by applying a weighted scoring function based on user-defined importance metrics and principles of financial planning science.

According to various embodiments, each source-of-funds priority rank and receiver-of-funds priority rank for a virtual account i is computed by a weighted scoring function that combines user-defined importance metrics with principles of financial planning science.

Let i index virtual accounts and let M denote the set of scoring components. Define a normalized feature vector φi=[φi,1, φi,2, . . . , φi,|M|], where each component is scaled to [0,1] and derived as follows:

### User-Defined Importance Metrics:

φi,importance captures the user's stated importance for account i (e.g., slider input on a 0-100 scale mapped to [0,1]).
φi,urgency reflects user-specified time sensitivity (e.g., target-by-date proximity for a goal: φi,urgency=max{0, 1−days_remaining/threshold}).

### Financial Planning Principles:

φi,necessity encodes whether the account is a “need” up to a minimum level (e.g., rent, utilities) using an indicator or a ramp up to a mandated minimum (1 at or below minimum required level, tapering down above it).
φi,rate reflects carrying cost or opportunity cost (e.g., normalized interest rate for high-interest debt; normalized expected shortfall risk for emergency fund).
φi,liquidity reflects the recommended preservation of liquid buffers (e.g., higher scores for buffer/emergency fund until target achieved).
φi,obligation reflects contractual payment requirements (e.g., proximity to due date and magnitude of minimum payment due).

### Receiver-of-Funds Priority Rank

Compute a receiver score for account i as a convex combination:

$${R}_{i}^{raw} = {\sum }_{m ∈ M} \qquad {α}_{m} {ϕ}_{i , m}$$

subject to αₘ≥0 and Σₘαₘ=1, where αₘ are weights. Exemplary weights incorporate both user preference and planning guidance, for example:
αimportance=0.35, αurgency=0.10, αnecessity=0.25, αrate=0.15, αliquidity=0.10, αobligation=0.05.

Optionally, apply tiering or monotone transforms to emphasize mandatory categories:

$${R}_{i} = min \{ 1 , {β}_{tier} ( i ) \cdot {R}_{i}^{raw} \}$$

where βₜᵢₑᵣ(i)≥1 for needs up to a minimum threshold and equals 1 otherwise. The resulting Rᵢ is then mapped to discrete receiver tiers (e.g., high/medium/low) or retained as a continuous rank for optimization.

### Source-of-Funds Priority Rank

Compute a source score that inversely reflects desirability of drawing funds from account i. For accounts where preservation is preferred (e.g., emergency fund at sub-target, retirement accounts, essential needs), increase the score to reduce sourcing. One implementation uses complementary features and weights:

$${S}_{i}^{raw} = {\sum }_{m ∈ M} \qquad {γ}_{m} {ψ}_{i , m}$$

where ψ_{i,m} reuse or invert selected q-components, and γₘ are nonnegative weights summing to 1. For example:
ψi,importance=1−φi,importance (preserve highly important accounts),
ψi,liquidity=1−φi,liquidity (discourage sourcing from low-liquidity assets),
ψi,rate=φi,rate for assets (prefer sourcing from low-return assets before sourcing from high-return assets) or 1−φi,rate for liabilities (prefer reducing high-rate debt rather than adding to it by sourcing from it),
ψi,necessity=φi,necessity (discourage sourcing from accounts tied to mandatory needs),
ψi,obligation=φi,obligation (discourage sourcing that would jeopardize imminent obligations).

Example weights: γimportance=0.30, γliquidity=0.25, γrate=0.20, γnecessity=0.15, γobligation=0.10. Apply a preservation boost for protected classes (e.g., retirement, mandated insurance reserves):

$${S}_{i} = min \{ 1 , {κ}_{protect} ( i ) \cdot {S}_{i}^{raw} \}$$

with κ_{protect}(i)>1 for protected accounts and 1 otherwise. Higher Sᵢ indicates lower preference to source funds from account i.

### Numerical Illustration

Assume four virtual accounts: Rent (A1: need), Emergency Fund (A2: financial security), Credit Card Debt (A3: liability), Dining Out (A4: want). Suppose normalized features are:
A1 Rent: φimportance=0.9, φnecessity=1.0 (up to minimum), φurgency=0.7 (due soon), φrate=0.0, φliquidity=0.3, φobligation=0.8.
A2 Emergency Fund (below target): φimportance=0.7, φnecessity=0.6, φurgency=0.4, φrate=0.1 (low yield), φliquidity=1.0, φobligation=0.0.
A3 Credit Card Debt (April 24%): φimportance=0.8, φnecessity=0.7 (minimum payment), φurgency=0.6 (payment upcoming), φrate=1.0, φliquidity=0.9 (payment reduces revolving balance), obligation=0.7.
A4 Dining Out: φimportance=0.5, φnecessity=0.0, φurgency=0.0, φrate=0.0, φliquidity=0.0, φobligation=0.0.

Receiver scores with the α-weights above:

$$A 1 \text{:} Rraw = 0.35 \cdot 0.9 + 0 \text{.10} \cdot 0.7 + 0.25 \cdot 1. + 0.15 \cdot 0. + 0 \text{.10} \cdot 0.3 + 0 \text{.05} \cdot 0.8 = 0.315 + 0.07 + 0.25 + 0 + 0.03 + 0.04 = 0.7 5.$$

$$A 2 \text{:} Rraw = 0.35 \cdot 0.7 + 0 \text{.10} \cdot 0.4 + 0.25 \cdot 0.6 + 0.15 \cdot 0.1 + 0.1 \cdot 1. + 0.05 \cdot 0. = 0.2 \; 45 + 0.04 + 0.15 + 0.015 + 0.10 + 0 = 0.5 5.$$

$$A 3 \text{:} Rraw = 0.35 \cdot 0.8 + 0 \text{.10} \cdot 0.6 + 0.25 \cdot 0.7 + 0.15 \cdot 1. + 0 \text{.10} \cdot 0.9 + 0 \text{.05} \cdot 0.7 = 0.28 + 0.06 + 0.175 + 0.15 + 0.09 + 0.035 = 0 \text{.79} .$$

$$A 4 \text{:} Rraw = 0 \text{.35} \cdot 0.5 + 0 \text{.10} \cdot 0. + 0.25 \cdot 0. + 0.15 \cdot 0. + 0.1 \cdot 0. + 0 \text{.05} \cdot 0. = 0.175 .$$

After tiering (e.g., βtier=1.2 for needs up to minimum, 1.0 otherwise) and clipping to 1.0:

$$A 1 \text{:} R = min ( 1 , 1.2 \cdot 0.705 ) = 0.8 46.$$

$$A 2 \text{:} R = 0. 5 5.$$

$$A 3 \text{:} R = 0. 7 9.$$

$$A 4 \text{:} R = 0.175 .$$

Source scores with γ-weights and protection κprotect=1.3, using complements for ψ where applicable:
For A1 Rent (avoid sourcing): ψimportance=0.1, ψliquidity=0.7, ψrate=1−0.0=1.0 (no yield to preserve; can set to 0.5 to moderate), ψnecessity=1.0, ψobligation=0.8. Sraw=0.30·0.1+0.25.0.7+0.20·1.0+0.15·1.0+0.10·0.8=0.03+0.175+0.20+0.15+0.08=0.635.
For A2 Emergency Fund (strongly avoid sourcing while below target): ψimportance=0.3, ψliquidity=0.0, ψrate=1−0.1=0.9, ψnecessity=0.6, ψobligation=0.0. Sraw=0.30·0.3+0.25·0.0+0.20·0.9+0.15·0.6+0.10·0.0=0.09+0+0.18+0.09+0=0.36.
For A3 Credit Card Debt (cannot source; only receives payments): set S very high by rule, e.g., S=1.0.
For A4 Dining Out (easy to source from wants): ψimportance=0.5, ψliquidity=1.0, ψrate=1−0.0=1.0, ψnecessity=0.0, ψobligation=0.0. Sraw=0.30.0.5+0.25·1.0+0.2·0.1.0+0.15·0.0+0.10·0.0=0.15+0.25+0.20=0.60.

### Interpretation

Receiver rank ordering: Credit Card Debt (0.79) and Rent (0.846 after tier boost) rank highest, then Emergency Fund (0.55), then Dining Out (0.175).

Source rank ordering (higher S=less preferred source): Credit Card Debt (1.0, do not source), Rent (0.635, avoid sourcing), Emergency Fund (0.36, discourage sourcing while below target), Dining Out (0.60, relatively acceptable to cut/supply funds from discretionary wants). These ranks directly parameterize the optimization constraints and tier activations described elsewhere in the disclosure.

Example of visualization elements directly from precomputed values of the intertemporal allocation vector within secure isolated memory, according to various embodiments.

According to various embodiments, a computer-implemented method provides a dynamic virtual representation of a user's financial life by generating, rendering, and updating visualization elements directly from precomputed values of the intertemporal allocation vector within secure isolated memory.

According to various embodiments, a set of virtual accounts is instantiated for the user's income sources, needs, wants, and financial security sub-areas. Each virtual account is assigned a source-of-funds priority rank and a receiver-of-funds priority rank computed by a weighted scoring function. The dynamic optimization engine computes a time-stamped intertemporal allocation vector over weekly intervals, where each record specifies, for a given account and interval, an amount and directive type. The visualization module retrieves these precomputed values and renders a dynamic virtual representation comprising grouped graphical elements, circles for Needs, Wants, and Financial Security and bars for individual virtual accounts, whose sizes scale with allocated amounts or balances.

According to various embodiments, animated flows are drawn between elements in accordance with the intertemporal allocation vector, showing sequential cash movements (e.g., income to Needs before Wants and Financial Security). Interactive controls are exposed to the user to adjust priority ranks and per-account allocations. When the user increases the receiver rank of a retirement savings account, the system triggers an event-driven, interval-local re-optimization confined to future intervals. The updated directives are written back to the intertemporal allocation vector, and the graphical elements automatically rescale and re-animate without invoking a full-model re-computation, providing sub-second feedback.

For example, with monthly income of $4,000, the representation initially depicts allocations of $2,000 to Rent (Needs), $400 to Emergency Fund (Financial Security), $300 to Credit Card payment (Financial Security), and $1,300 to Dining Out (Wants). If the user drags a lever to prioritize retirement, the engine shifts $150 from Dining Out to Retirement Contributions in impacted intervals while preserving previously satisfied rent and minimum debt obligations via hierarchical constraints. The circles for Wants and Financial Security resize to reflect the change, and animated flows update to show increased retirement contributions. The interface simultaneously provides personalized feedback explaining the trade-offs and projected goal timelines, all derived from the updated intertemporal allocation vector computed and stored within the secure isolated memory.

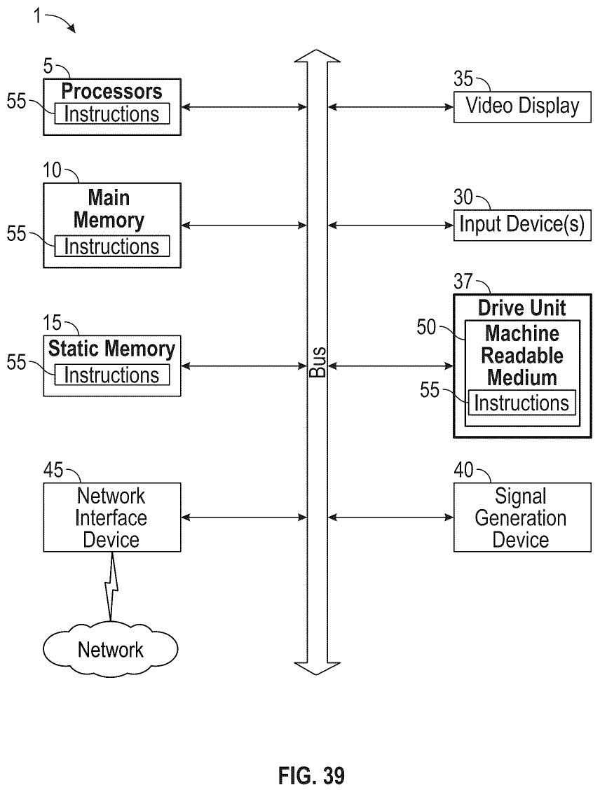

FIG. 39 illustrates an exemplary computer system that may be used to implement embodiments of the present technology. FIG. 39 illustrates a computer system for implementing systems and methods according to exemplary embodiments of the present technology. FIG. 39 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g. a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g. Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 are those typically found in computer systems that may be suitable for use with embodiments of the present disclosure and are intended to represent a broad category of such computer components that are well known in the art. Thus, the computer system 1 can be a personal computer (PC), handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g. computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer system 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

Thus, the technology for dynamic, intertemporal, priorities-based optimization of a user's personal cash flow and balance sheet using a dynamic virtual representation and virtual accounts is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed:

1. A computer-implemented method for dynamic, intertemporal, priorities-based optimization of virtual accounts of a user, the method comprising:
receiving financial inputs of the user from one or more data sources;
generating, in a secure isolated memory, a plurality of virtual accounts using the financial inputs, the plurality of virtual accounts each corresponding to a discrete element of a financial life of the user and tagged with a source-of-funds priority rank and a receiver-of-funds priority rank based on goals of the user and financial planning principles;
determining, via a dynamic optimization engine, for a plurality of future time intervals, an intertemporal allocation vector that sources and distributes cash flow, including by adding to and removing from balances of the plurality of virtual accounts, among the plurality of virtual accounts according to their respective priority ranks to achieve the goals of the user; and
completing real-time transfers between the plurality of virtual accounts to execute sourcing and distribution of cash flow between the plurality of virtual accounts.

2. The computer-implemented method of claim 1, wherein updated financial inputs are received in real-time and the intertemporal allocation vector is automatically re-optimized within the secure isolated memory without synchronizing with external custodial accounts thereby decreasing latency of the dynamic optimization engine.

3. The computer-implemented method of claim 1, wherein the receiving financial inputs comprises automatically importing one or more of transactional data and account balance information from at least one linked external custodial account through an application programming interface.

4. The computer-implemented method of claim 1, wherein the plurality of virtual accounts comprise virtual accounts for income sources, spending categories classified as needs, spending categories classified as wants, savings for financial security, assets, debts and other liabilities, the plurality of virtual accounts having both the source-of-funds priority rank and the receiver-of-funds priority rank.

5. The computer-implemented method of claim 1, wherein the source-of-funds priority rank and the receiver-of-funds priority rank are refined based on factors of the user including geographic location of the user, age of the user, and other factors of the user identified based on analysis of actions of the user and performance of the user over time.

6. The computer-implemented method of claim 1, wherein the determining, via the dynamic optimization engine, for the plurality of future time intervals, the intertemporal allocation vector comprises solving an intertemporal constrained optimization problem that maximizes a weighted aggregate of user goal-attainment scores subject to the source-of-funds priority rank and the receiver-of-funds priority rank for the plurality of virtual accounts.

7. The computer-implemented method of claim 1, wherein the dynamic optimization engine is configured to preserve previously satisfied higher-ranked priorities by imposing hierarchical constraints during each re-optimization cycle.

8. The computer-implemented method of claim 7, wherein encoding hierarchical constraints in each time interval mitigates oscillations during successive re-optimization cycles.

9. The computer-implemented method of claim 1, further comprising providing personalized feedback and recommendations for user financial actions to balance competing priorities and achieve financial goals based on the intertemporal allocation vector via a user interface.

10. The computer-implemented method of claim 9, wherein the providing personalized feedback comprises generating a prioritized set of recommended actions that include at least one of adjusting spending on needs, adjusting discretionary spending, redirecting funds toward a savings goal, making an additional payment to reduce debt, and updating times at which goals will be reached or debts repaid.

11. The computer-implemented method of claim 9, wherein the providing personalized feedback comprises generating a prioritized set of recommended transactions that include an optimal amount, sequence, and timing of payments on each of multiple sources of debt over time.

12. The computer-implemented method of claim 9, wherein the providing personalized feedback comprises generating a personalized financial health report of the user that includes one or more of a summary analysis of a current financial situation of the user, a diagnosis of the user, financial health metrics of the user, recommended actions of the user, and results of a scan for risks of the user, and personalized education regarding financial science built into a plan of the user.

13. The computer-implemented method of claim 9, wherein the providing personalized feedback comprises generating a response to an unplanned event by specifying a sourcing and allocation of funds across the plurality of virtual accounts that achieves goals of the user.

14. The computer-implemented method of claim 1, further comprising rendering a dynamic virtual representation of the plurality of virtual accounts and the intertemporal allocation vector via a dynamic virtual representation module, the dynamic virtual representation being a graphical depiction comprising graphical elements corresponding to the plurality of virtual accounts dynamically re-scaling based on changes to the intertemporal allocation vector.

15. The computer-implemented method of claim 14, wherein the dynamic virtual representation comprises an interactive graphical user interface that depicts an amount of cash flow allocated to an individual virtual account of the plurality of virtual accounts or a group of virtual accounts of the plurality of virtual accounts as a visual element whose size scales with the amount of cash flow allocated to the individual virtual account or the group of virtual accounts; and resizes the visual element in real-time when the amount of allocated cash flow is updated.

16. The computer-implemented method of claim 14, wherein the dynamic virtual representation comprises an interactive graphical user interface that animates cash flow paths among visual elements in accordance with results of the determining, via the dynamic optimization engine, for the plurality of future time intervals, the intertemporal allocation vector that sources and distributes cash flow.

17. The computer-implemented method of claim 14, wherein the dynamic virtual representation comprises an interactive graphical user interface that depicts current or projected future balances of the plurality of virtual accounts as a visual element whose size scales with a size of that balance and resizes the visual element in real-time when that balance is updated.

18. The computer-implemented method of claim 14, wherein rendering the graphical depiction includes providing interactive zoom functionality to transition from an aggregate view encompassing multiple virtual accounts of the plurality of virtual accounts to a subset of the multiple virtual accounts.

19. The computer-implemented method of claim 14, further comprising generating a scenario simulation that projects adjustments to the intertemporal allocation vector in response to hypothetical user modifications of a priority of the user.

20. The computer-implemented method of claim 15, wherein the graphical depiction includes visual levers, the visual levers enabling the user to incrementally adjust allocations to specific financial goals or one or more virtual accounts of the plurality of virtual accounts, and to immediately view in real-time an impact on the plurality of virtual accounts.

21. The computer-implemented method of claim 1, wherein the intertemporal allocation vector is computed for user-defined periodic intervals.

22. The computer-implemented method of claim 1, wherein each source-of-funds priority rank and receiver-of-funds priority rank is determined by applying a weighted scoring function based on user-defined importance metrics and principles of financial planning science.

23. The computer-implemented method of claim 1, wherein the secure isolated memory is implemented within a hardware-based trusted execution environment that prohibits persistent storage of user-identifiable financial data outside the hardware-based trusted execution environment.

24. The computer-implemented method of claim 1, further comprising generating alerts to notify the user of risks, based on analysis of the plurality of virtual accounts, the risks including risks associated with failure of the user to execute one or more actions recommended by the determining, via the dynamic optimization engine, for the plurality of future time intervals, the intertemporal allocation vector that sources and distributes cash flow.

25. The computer-implemented method of claim 1, wherein the intertemporal allocation vector is computed for a plurality of scenarios for uncertain future events at one or more future time intervals and dynamically distributes cash flow and reallocates balances among the plurality of virtual accounts according to their respective priority ranks to optimize achievement of financial goals of the user over time across these scenarios for the uncertain future events.

26. The computer-implemented method of claim 25, wherein the intertemporal allocation vector computed for the plurality of scenarios for uncertain future events at one or more future time intervals is used to project balances in the plurality of virtual accounts for each future time interval and scenario.

27. The computer-implemented method of claim 1, wherein the intertemporal allocation vector is automatically updated in response to changes in the financial inputs, the financial inputs including new transactions, modifications to assets or liabilities, or updates to goals and priorities of the user.

28. The computer-implemented method of claim 1, wherein incremental interval-local updates reduce end-to-end re-optimization latency compared to full-model re-computation.

29. The computer-implemented method of claim 1, wherein the receiving financial inputs comprises validating and normalizing API call payloads within the secure isolated memory and mapping them to discrete events that trigger interval-local updates to the intertemporal allocation vector.

30. A computer-implemented method for dynamic, intertemporal, priorities-based optimization, the method comprising:
receiving inputs related to a financial life of a user;
generating virtual accounts for a plurality of elements of the financial life of the user using the inputs, the virtual accounts being assigned a source-of-funds priority rank and receiver-of-funds priority rank based on goals of the user and financial planning principles, the virtual accounts being secure and isolated using a hardware-based trusted execution environment, the hardware-based trusted execution environment managing financial data by operating within memory and not relying on external data synchronization with external custodial accounts thereby reducing latency in processing for enabling the dynamic, intertemporal, priorities-based optimization;
computing and storing a time-stamped intertemporal allocation vector in a secure isolated memory,
determining a dynamic, intertemporal, priorities-based optimization of allocation of cash flow to and reallocation of balances of the virtual accounts to achieve goals of the user;
rendering from precomputed vector values a dynamic virtual representation of the financial life of the user to display the dynamic, intertemporal, priorities-based optimization of allocation of cash flow to and reallocation of the balances of the virtual accounts to achieve the goals of the user;
performing incremental interval-local re-optimization that preserves hierarchical constraints to update the dynamic, intertemporal, priorities-based optimization of allocation of cash flow to and reallocation of the balances of the virtual accounts in response to changes in the inputs; and
providing personalized feedback for financial actions of the user to balance competing priorities and achieve financial goals based on the dynamic, intertemporal, priorities-based optimization of allocation of cash flow to and reallocation of the balances of the virtual accounts.

31. A computer-implemented method for providing a dynamic virtual representation of a user's financial life, the method comprising:
generating, by one or more processors, a dynamic virtual representation comprising a plurality of virtual accounts, the plurality of virtual accounts corresponding to elements of a financial life of a user and assigned a source-of-funds priority rank and receiver-of-funds priority rank based on goals of the user and financial planning principles;
visually grouping the plurality of virtual accounts into categories including needs, wants, and financial security, and representing each of the categories and the plurality of virtual accounts as graphical elements, the graphical elements scaling by size according to an amount of funds allocated;
animating flows of funds among the graphical elements in accordance with a dynamically determined, intertemporal, priorities-based optimization of allocation of cash flow to and reallocation of balances of the plurality of virtual accounts;
enabling interactive user input to adjust the source-of-funds priority rank and the receiver-of-funds priority rank;
wherein the graphical elements automatically re-scale and underlying optimization is re-computed in real-time in response to the interactive user input or updated financial data using the plurality of virtual accounts; and
providing, via the dynamic virtual representation, personalized recommendations and feedback for financial actions to balance competing priorities and achieve financial goals of the user.
